(19) United States
(12) Patent Application Publication
(10) Pub. No.: US 2016/0044621 A1
(43) Pub. Date: Feb. 11, 2016

(54) METHOD AND APPARATUS FOR CONTEXT-AWARE SYNCHRONIZATION FOR PEER-TO-PEER COMMUNICATION

(71) Applicant: INTERDIGITAL PATENT HOLDINGS, INC., Wilmington, DE (US)

(72) Inventors: Zongrui DING, Portland, OR (US); Hongkun LI, Malvern, PA (US); Qing LI, Princeton Junction, NJ (US); Chonggang WANG, Princeton, NJ (US); Paul L. RUSSELL, Jr., Pennington, NJ (US)

(21) Appl. No.: 14/777,205

(22) PCT Filed: Mar. 13, 2014
(86) PCT No.: PCT/US14/26048

§ 371 Date: Sep. 15, 2015

Related U.S. Application Data
(60) Provisional application No. 61/789,608, filed on Mar. 15, 2013.

(51) Int. Cl. H04W 56/00; H04L 29/08

(52) U.S. Cl. CPC H04W 56/0025; H04L 67/104; H04W 84/18

(57) ABSTRACT

Apparatuses, computer readable media, and methods are disclosed for context aware synchronization for peer-to-peer communication. A method may include extracting from a super beacon synchronization information. The method may further include synchronizing with a beacon of an application based on the synchronization information. Another method may include extracting synchronization information from a received beacon, if the received beacon is for a first application. The method may further include if the received beacon is not for a first application, then extracting common beacon synchronization information from the received beacon, scanning for the common beacon based on the extracted common beacon synchronization information, receiving the common beacon, and extracting common channel synchronization information from the common beacon. Another method may include transmitting synchronization information in a data packet to a WTRU, if there is data to be transmitted, and otherwise transmitting synchronization information in a dummy packet to the second WTRU.

### CROSS REFERENCE TO RELATED APPLICATIONS

This application claims the benefit of U.S. Provisional Application No. 61/789,608 filed on Mar. 15, 2013, the entire contents of which is hereby incorporated by reference.

### BACKGROUND

Wireless transmit and receive units (WTRU) such as cellular telephones that communicate with one another directly and not through a centralized network device may be communicating by peer to peer communication where the WTRU may be called a peer.

Peer to peer communication is being more and more widely used. However, peers often have difficulty communicating with one another because of difficulties synchronizing the communication with one another particularly when many peers are available. Moreover, the peers may be running multiple applications such as telephone calls and social media which may require different synchronization methods or may require the peer synchronizing with more than one group of peers. The type and kind of synchronization the peer performs may be called a context for the communication.

Therefore, there is a need for methods and apparatuses for context-aware synchronization for peer-to-peer communication.

### SUMMARY

Apparatuses, computer readable media, and methods are disclosed for context aware synchronization for peer-to-peer communication. The method may include extracting from a received super beacon application synchronization. The method may further include synchronizing with a first beacon of the first application based on the first application synchronization information, if the extracted application synchronization information includes first application synchronization information for the first application.

In some embodiments, the method includes receiving a first frame associated with the first application transmitted by a first peer of the WTRU as part of peer-to-peer communication associated with the first application.

The extracted application synchronization information may include an application offset list (AOL) including synchronization information for one or more applications.

A wireless transmit/receive unit (WTRU) for peer-to-peer communication is disclosed. The WTRU may include a transceiver configured to receive a super beacon, extract from the received super beacon application synchronization information, and synchronize with a first beacon of the first application based on a first application synchronization information, if the extracted application synchronization information includes first application synchronization information for the first application.

A method on a wireless transmit/receive unit (WTRU) for peer-to-peer communication is disclosed. The method may include extracting first application synchronization information from the received beacon, if a received beacon is for a first application. The method may further include if the received beacon is not for a first application, then extracting common beacon synchronization information from the received beacon, scanning for the common beacon based on the extracted common beacon synchronization information, receiving the common beacon, and extracting common channel synchronization information from the common beacon.

A method on a wireless transmit/receive unit (WTRU) for peer-to-peer communication is disclosed. The method may include transmitting synchronization information in a data packet to a second WTRU, if there is data to be transmitted, and transmitting synchronization information in a dummy packet to the second WTRU, if there is not data to be transmitted.

The method may include if a synchronization response is received from the second WTRU, then determining whether or not the synchronization response indicates that the synchronization was successful, and if the synchronization response indicates the synchronization was not successful then re-transmitting the data packet or the dummy packet.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 illustrates an example of a peer-to-peer network for context-aware synchronization according to some embodiments;

FIG. 3 illustrates a method of synchronizing to the coordinator without tracking the beacons of the coordinator;

FIG. 4 illustrates a method of synchronizing to the coordinator with tracking the beacons of the coordinator;

FIG. 5 illustrates an example of synchronization without beacons;

FIG. 6 illustrates an example of a peer to peer network (P2PNW) with centralized control according to some disclosed embodiments;

FIG. 7 illustrates an example of a super frame according to some disclosed embodiments;

FIG. 8 illustrates an example of a frame map according to some disclosed embodiments;

FIG. 9 illustrates an example of an application beacon according to some disclosed embodiments;

FIG. 10 illustrates an example of a super beacon offset (SBO) according to some disclosed embodiments;

FIG. 11 illustrates an example of a method for context aware initial synchronization (CAIS);

FIG. 12 illustrates an example of a method for context-aware peer-to-peer synchronization;

FIG. 13 illustrates an example of a peer to peer network (P2PNW) with hybrid control according to some disclosed embodiments;

FIG. 14 illustrates an example of a common beacon (CB) according to some disclosed embodiments;

FIG. 15 illustrates an example of a non-common beacon according to some disclosed embodiments;

FIG. 16 illustrates an example of an application beacon according to some disclosed embodiments;

FIG. 17 illustrates an example of a super frame according to some disclosed embodiments;

FIG. 18 illustrates an example of a method for context-aware synchronization for peer-to-peer communication according to some embodiments;

FIG. 19 illustrates an example of a peer to peer network (P2PNW) according to some disclosed embodiments;

FIG. 20 illustrates an example of a peer to peer network (P2PNW) with distributed control according to some disclosed embodiments;

FIG. 21 illustrates an example of an inter-P2PNW synchronization according to some disclosed embodiments;

FIG. 22 illustrates an example of a tree structure illustrating a multi-hop peer-to-peer network where beacons are used for synchronization;

FIG. 23 illustrates an example of a method for beacon-based synchronization for centralized P2PNWs;

FIG. 24 illustrates an example of a beacon of a virtual leader with reserved time slots;

FIG. 25 illustrates an example of a method of beacon-less synchronization for a virtual leader and/or sub virtual leader with centralized communication;

FIG. 26 illustrates an example of a method of beacon-less synchronization for a peer that is not acting as a virtual leader or a sub virtual leader with centralized communication;

FIG. 27 illustrates an example of peers with distributed communication where peers may communicate with one another without sending and receiving data through an associated virtual leader or sub virtual leader;

FIG. 28 illustrates an example of coordinating horizontal synchronization with vertical synchronization;

FIG. 29 illustrates an example of beacon-less synchronization for distributed communication;

FIG. 30 illustrates a method of beacon-based multi-hop synchronization initiated by a peer in a peer-to-peer network with centralized communication;

FIG. 31 illustrates a method of beacon-based multi-hop synchronization initiated by a peer in a peer-to-peer network with centralized communication;

FIG. 32 illustrates a method of beacon-based multi-hop synchronization initiated in a peer-to-peer network with centralized communication;

FIG. 33 illustrates an example of a method for beacon-less multi-hop synchronization on a virtual leader or a sub virtual leader; and

FIG. 34 illustrates an example of a method for beacon-less multi-hop synchronization on a peer.

### DETAILED DESCRIPTION

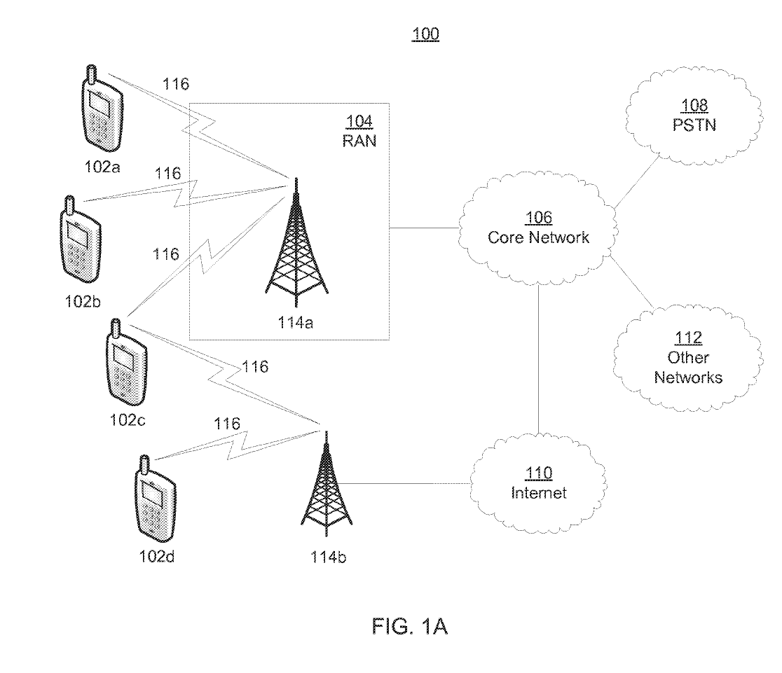

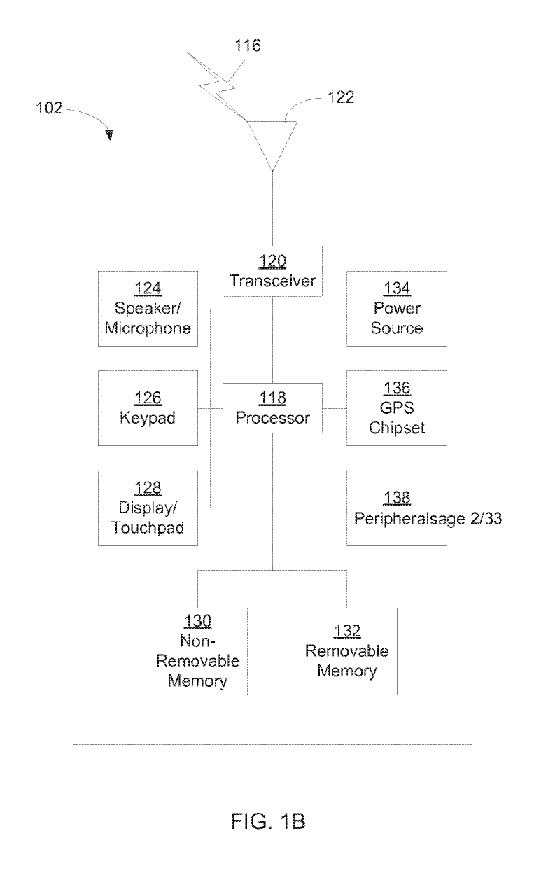

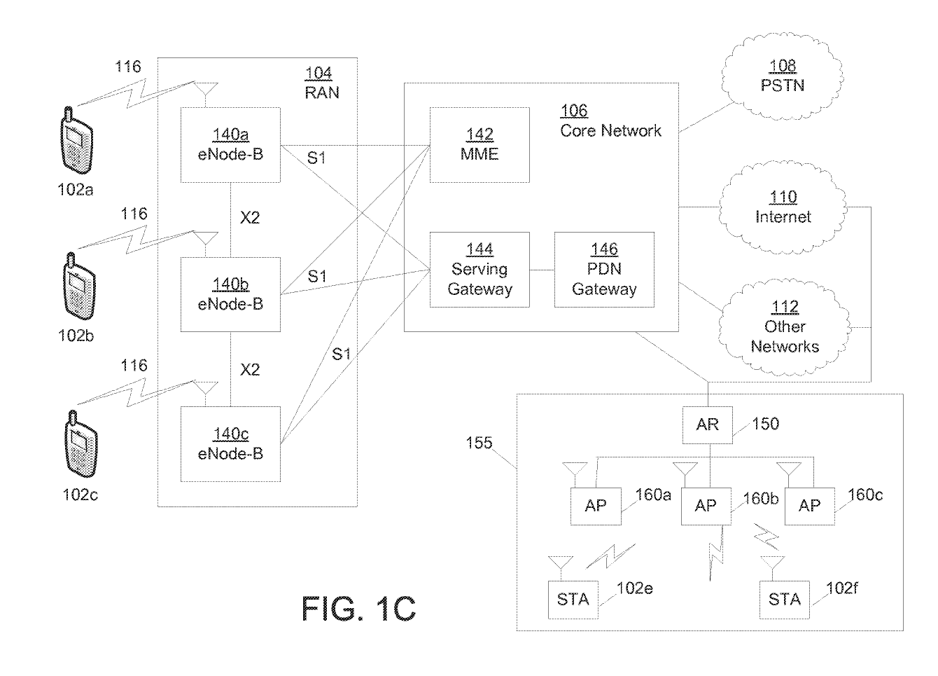

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode-Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode-B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with STAs 170a, 170b, and 170c. A STA 170 may be a wireless device such as WTRU 102.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the other networks 112, which may include other wired or wireless networks that are owned and/or operated by other service providers.

In some embodiments, the WTRU 102 may be a device that generates data such as a water meter, inventor detector, door sense, temperature sensor, video camera, etc.

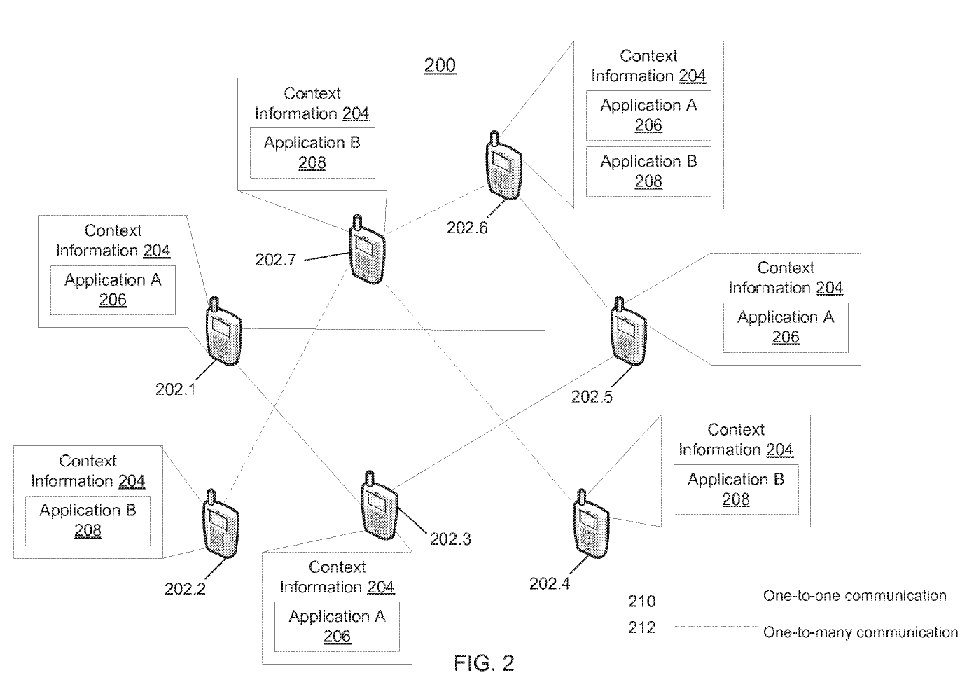

FIG. 2 illustrates an example of a peer-to-peer network for context-aware synchronization 200 according to some embodiments.

Illustrated in FIG. 2 are peers 202, one-to-one communication 210, and one-to-many communication 212. A peer 202 may include context information 204. Peer 202.1 includes context information 204, which includes application A 206. Peer 202.2 includes context information 204 which includes application B 208. Peers 202.1, 202.3, 202.5, and 202.6 may be communicating within a peer-to-peer network where the peers 202 use one-to-one communication 210. Peers 202.7, 202.6, 202.4, and 202.2 may use one-to-many communication 212. In some embodiments, an application 206, 208 may use both one-to-one communication 210 and one-to-many communication 212. A peer 202 may be communicating with more than one application 206, 208. For example, peer 202.6 is communicating with application A 206 and application B 208.

A peer 202 may be a WTRU 102, mobile station (MS), a user device, full-function device (FFD), reduced-function devices (RFD), automobile, medical devices, smart meters, smart phones, tablets, laptops, game consoles, set-top boxes, cameras, printers, sensors, home gateways, an IEEE 802.15.8 compliant device, etc.

A peer 202 may be configured to unicast, multicast, or broadcast to other peers 202.

Context information 204 may include information about the peer 202, information regarding the peer-to-peer communications, the devices in the peer-to-peer communication, information about an application, information about a triggering entity, information regarding a control scheme such as centralized, hybrid, or distributed, and information regarding channels to scan, a scan period, slot number, code, etc.

In some embodiments, the peer-to-peer network 200 does not have infrastructure for synchronization. In some embodiments, the peer-to-peer network 200 does not have a centralized controller for handling application information, user information, scheduling among users, and connection management.

Application A 206 and/or application B 208 may be a social network application such as Facebook® or Twitter®. One-to-one communication 210 among two or more peers 202 may be required to support the social network application. For example, application A 206 may be a social networking application and peers 202.5, 202.6, 202.3, and 202.1 may be part of peer-to-peer network 200. Traffic data rates to support the one-to-one communication 210 for the social network application may be low for applications such as text-based chatting or high for application such content sharing.

Application A 206 and/or application B 208 may store broadcasts which may be advertising such as promotions or coupons. For example, application B 208 may be one-to-many communication 212 that is store broadcasts from peer 202.7 to peer 202.6, 202.4, and 202.2. The one-to-many communication 212 may require low data rates for some advertising such as coupons. The communication may be one-to-one communication 210 for personalized advertisements.

Application A 206 and/or application B 208 may be emergency services. Often emergency services are one-to-many communication 212 such as an emergency alarm, but one-to-one communication 210 may be needed for applications such as emergency safety management. An emergency services application may have a higher priority than other applications.

Application A 206 and/or application B 208 may be gaming applications. Multiple peers 202 may participate in interactive games using one-to-one communications 212. Games may require communications with a low latency.

Application A 206 and/or application B 208 may be smart transportation. For example, connected cars via car-to-car and/or car-to-infrastructure communication may support advanced applications such as congestion avoidance, accident avoidance, event notification, interactive transportation management such as carpooling and train scheduling, smart traffic control, etc. Data communications for smart transportation may be one-to-one 210 and/or one-to-many 212. The communication may need to be highly reliable with low latency. The communication may need to support critical real time applications such as collision avoidance.

Application A 206 and/or application B 208 may be network of network applications used for coverage extension of infrastructure or offloading from the infrastructure. Multi-hop communication may be used in the network of network applications. For example, a peer 202.5 may be in communication with an access point 160 and the peer 202.5 may be in one-to-one communication with peer 202.1. Peer 202.5 may relay communications between peer 202.1 and the access point 160.

The peers 202 may discover one another without associating with one another.

The peers 202 may be members of more than one peer-to-peer network 200. For example, peer 202.6 is a member of a peer-to-peer network 200 for application A 206 with peers 202.1, 202.3, and 202.5. Peer 202.6 is also a member of a peer-to-peer network 200 for application B with peers 202.4, 202.4, and 202.7. Peers 202 that are part of a peer-to-peer network 200 may be called a group of peers 202.

The one-to-one communication 210 and/or the one-to-many communication 212 may operate in licensed/unlicensed bands. The one-to-one communication 210 and/or the one-to-many communication 212 may operate according to one or more standards such as 802.15.8. Peer-to-peer communications may refer to the direct communication between any two peer 202 without any mediating (coordinating) device such as base stations 114.

In some embodiments, the peer 202 may be configured for peer aware communications.

Peer association may be method where a peer 202 associates with another peer 202 to establish a logical relationship with one another peer 202. In some embodiments, peers 202 may not become part of the same peer-to-peer network 200 before associating with one another. In some embodiments, applications 206, 208 of a first peer 202 may not communicate with applications 206, 208 of a second peer 202 until the first peer 202 and the second peer 202 have associated with one another. Peer association may be called peer attachment, peering, pairing, or link establishment.

Peer disassociation may be when a peer 202 disassociates with another peer 202 to cancel an existing association relationship with another peer 202.

Peer association update may be a method for a peer 202 to update an association identifier and/or association context of an existing association relationship with another peer 202.

Peer re-association may be methods used for a peer 202 to re-associate with a canceled association relationship with another peer 202.

Association context information (not illustrated) may be information about an established association relationship among peers 202.

An association identifier (not illustrated) may be a locally unique identifier to identify each established association relationship between peers 202.

In some embodiments, the peers 202 may discover one another by one of the following methods.

Operator free peer discovery may be a method where peers 202 discover one another without any support from a network infrastructure device such as a base station 114. The peers 202 may determine the proximity of other peers 202.

Operated assisted peer discovery may be a method where peers 202 may receive information from a network such as from a base station 114 that aids the peers 202 in discovering or associating with one another.

In some embodiments, peers 202 may discover one another without first associating with one another. In some embodiments, the peers 202 may perform discovery according to the Institute of Electrical and Electronic Engineers (IEEE) 802.15.8 standard. In some embodiments, the peers 202 may perform discovery at the PHY and MAC layer without performing association with one another.

Context aware initial synchronization (CAIS) may refer to a higher layer entity sending to a lower layer entity context information 204 for the purpose of synchronizing based on the context information 204. The synchronization may be to frame boundaries and slot boundaries of the frames and super frames of the desired applications based on the context information. For example, application A 206 may request that MAC and PHY layers of peer 202.1 synchronize based on context information 204 that is application A.

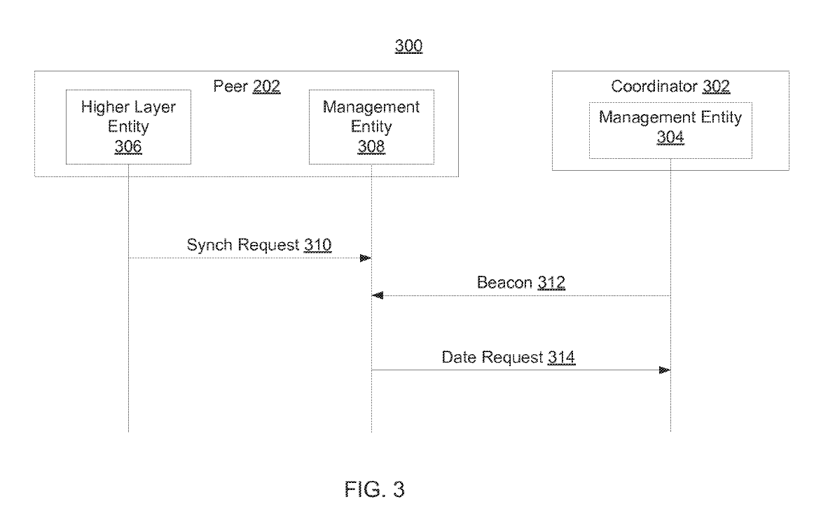

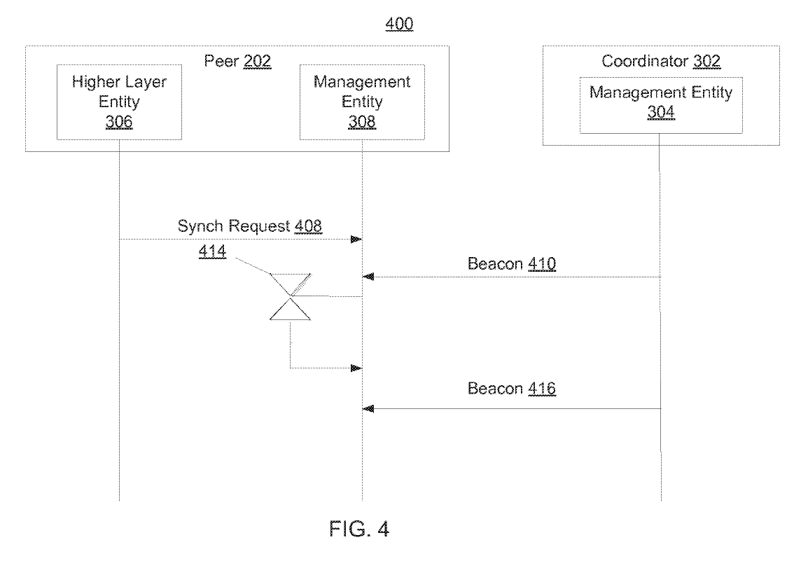

FIGS. 3 and 4 illustrate examples of synchronization methods. FIG. 3 illustrates a method 300 of synchronizing to the coordinator 302 without tracking the beacons 312 of the coordinator 302. Illustrated in FIG. 3 is a peer 202 and a coordinator 302. The peer 202 may include a higher layer entity 306 and a management entity 308. The higher layer entity 306 may be an entity at a higher layer than a physical or media access (MAC) layer. The management entity 308 may be a MAC layer management entity (MLME) 308. The coordinator 302 may be a peer 202 or a network infrastructure device such as a base station 114. The coordinator 302 may include a management entity 304. The management entity 304 may be a MAC layer management entity (MLME) 304.

The method 300 may begin with the higher layer entity 306 sending a synchronization request 310 to the management entity 308. The synchronization request 310 may include an indication that the management entity 308 should not track the beacons 312 of the coordinator 302. The method 300 may continue with the management entity 308 scanning for a beacon 312 from the coordinator 302. The coordinator 302 may periodically transmit a beacon 312, which is received by the management entity 308. In some embodiments, the management entity 308 may only read beacons 312 that include an identification that matches an identification associated with the communication between the peer 202 and the coordinator 302. For example, the identification may be context information. As another example, the identification may be a personal area network (PAN) identification or an association identification.

The method 300 may continue with the management entity 308 determining that the beacon 312 indicates that there is data available for the peer 202. The method 300 may continue with the management entity 308 transmitting a data request 314 to the coordinator 302 for coordinator 302 to transmit data that was indicated as available in the beacon 312, 202. The method 300 may continue with the peer 202 receiving data from the coordinator 302 (not illustrated).

FIG. 4 illustrates a method 400 of synchronizing to the coordinator 302 with tracking the beacons 410, 416 of the coordinator 302. The method 400 of FIG. 4 may begin with the higher layer entity 306 sending a synchronization request 408 to the management entity 408. The synchronization request 310 may include an indication that the management entity 308 should track the beacons 410 of the coordinator 302. The method 400 may continue with the management entity 308 scanning for a beacon 410 from the coordinator 302. The coordinator 302 may transmit a beacon 410, which is received by the management entity 308. In some embodiments, the management entity 308 may only read beacons 410 that include an identification that matches an identification associated with the communication between the peer 202 and the coordinator 302.

The method 400 may continue with the management entity 308 determining that the beacon 410 indicates that there is not data available for the peer 202. The method 400 may continue with the management entity 308 synchronizing with the beacons 410, 416 of the coordinator 302. The management entity 308 may set a timer 414 that indicates when the management entity 308 should begin to scan for the next beacon 416 of the coordinator 302. The method 400 continues with the management entity 308 beginning to scan for a beacon 416 after timer 414 has expired. The method 400 may continue with the management entity 308 receiving the beacon 416. The method 400 may continue with the management entity 308 resetting the timer 414 (not illustrated). In an embodiment, the peer 202 and the coordinator 302 may be compliant with the IEEE 802.15.4 standard.

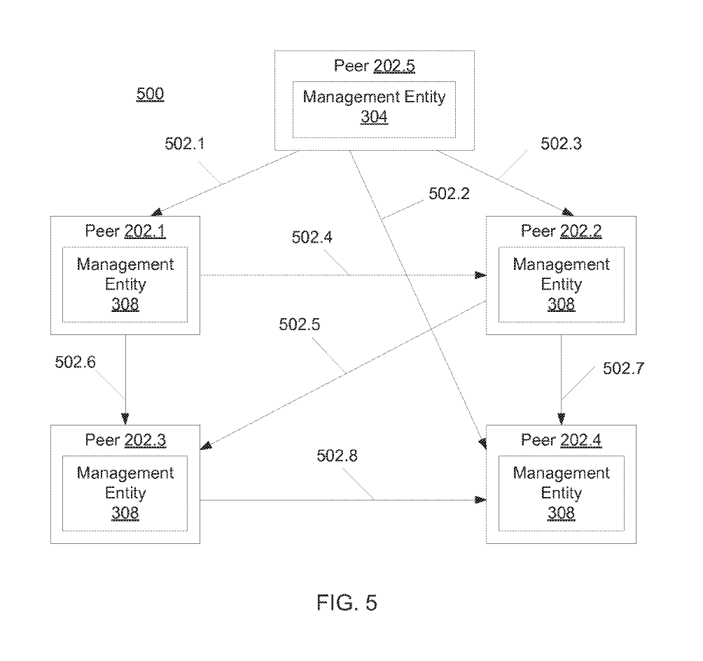

FIG. 5 illustrates an example of synchronization without beacons 500. Illustrated in FIG. 5 are peers 202 and communications 502. A peer 202.5 may act as a virtual leader, leader, coordinator, super virtual leader. The peers 202 may poll a peer 202.5 for data. A higher layer entity 306 (see FIG. 3) may instruct the management entity 308 to poll the coordinator 302 for data.

The peer 202.5 and the peers 202 may be configured to synchronize using time slotted channel hopping (TSCH) where communication 302 occurs in timeslots. To remain synchronized with one another the peer 202.5 and the peers 202 may maintain a synchronized time when timeslots begin and end.

The peer 202.5 may be configured to transmit a time, which may be a network time, to one or more of the peers 202. The peers 202 may be configured to periodically synchronize their time to the coordinator 302.

As illustrated in FIG. 5, peer 202.1 receives a communication 502.1 from peer 202.5. The communication 502.1 may include a time, and peer 202.2 may synchronize its time with the time received in the communication 502.1. Peer 202.1 may transmit its synchronized time in communication 502.6 to peer 202.3.

Peer 202.2 may receive communication 502.4 and communication 502.3, and peer 202.2 may synchronize its time with both communications 502.4 and 502.3. Peer 202.2 may transmit its synchronized time to peer 202.4 and peer 202.3.

Peers 202 and peer 202.5 may be configured to synchronize their time to other peers 202 in which they receive communication 502. A coordinator 302 or peer 202 may be selected to maintain the time to be synchronized with. In embodiments, the peer 202.5 may be a virtual leader or a super virtual leader.

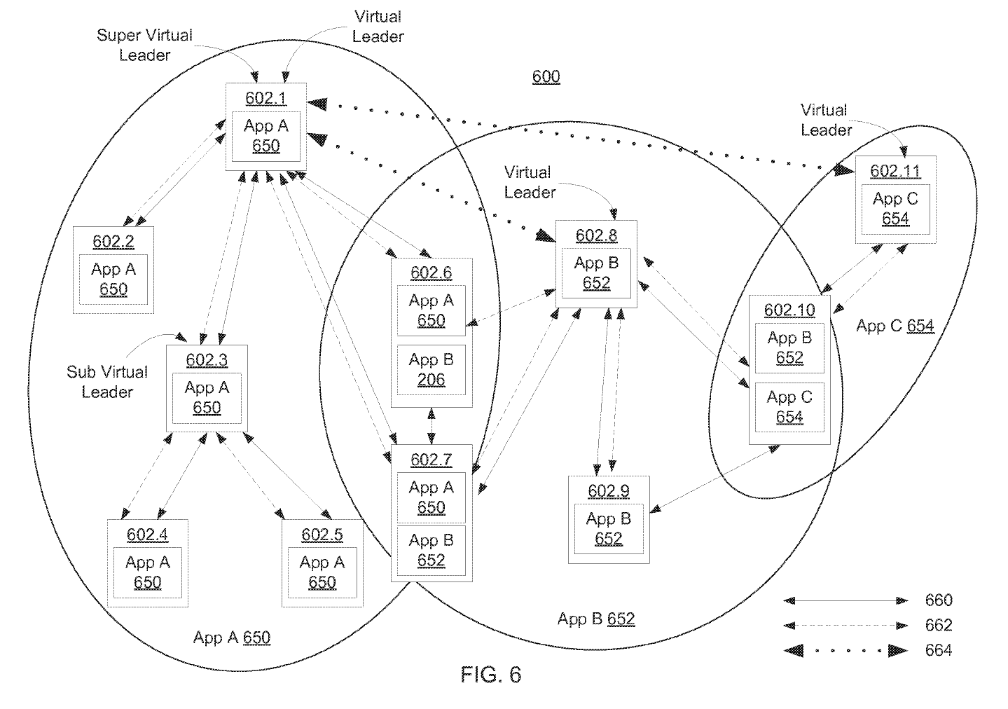

FIG. 6 illustrates an example of a peer to peer network (P2PNW) 600 with centralized control according to some disclosed embodiments.

Illustrated in FIG. 6 are peers 602, P2PNW for application A 650, P2PNW for application B 652, P2PNW for application C 654, data communication 660, virtual leader control information 662, and super leader control information 664.

Peer 602.1 may be configured to be a super virtual leader of all the P2PNWs and the virtual leader of P2PNW application A 650. Peer 602.3 may be configured to be a sub virtual leader of P2PNW of application A 650. Peer 602.8 may be configured to be a virtual leader of P2PNW application B 652. Peer 602.11 may be configured to be a virtual leader of P2PNW application C 654.

A peer 602 may be configured to unicast to another peer 602, to multicast to two or more peers 602, or to broadcast to peers 602.

The super virtual leader 602.1 may be configured to manage control related communications among P2PNWs in proximity. For example, as illustrated peer 602.1, the super virtual leader, manages the communications among application A 650, application B 652, and application C 654. The super leader 602.1 may use super leader control information 664 to communicate with virtual leaders 602.8, 602.11. The super virtual leader 602.1 may be a virtual leader defined to coordinate all virtual leaders of P2PNWs in proximity for centralized inter-P2PNWs control. The super virtual leader 602.1 may be the virtual leader for one or more of synchronization, power control, interference management, channel allocation, and accessing control. The super virtual leader 602.1 may be dynamically determined and/or changed among the virtual leaders 602.8, 602.11 in proximity or other peers 602 or sub virtual leaders 602.3. The super virtual leader 602.1 is the top leader of the virtual leaders hierarchical structure for centralized inter-P2PNWs control.

The virtual leaders 602.1, 602.8, and 602.11 may be configured to manage control related communications directly or through sub virtual leaders 602.3 to manage P2PNWs application A 650, application B 652, and application C 654, respectively. A virtual leader 602.1, 602.8, and 602.11 is a peer 602 defined to represent, manage, and coordinate the P2P communications among a group of peers 602 sharing the same context-based service or application, i.e. within a P2PNW, for centralized intra-P2PNW control. A virtual leader 602.1, 602.8, and 602.11 may be dynamically determined and/or changed within the group (P2PNW). A virtual leader 602.1, 602.8, and 602.11 may perform one or more of the following functions for the group (P2PNW): context management, context-aware discovery broadcast, context-aware peer association, group membership management, synchronization, link management, channel allocation and accessing control, reliable data transmission, routing management, power control and interference management, and channel measurement coordination. In some embodiments, a peer 602 may only be the virtual leader 602.1, 602.8, and 602.11 for one application (P2PNW), and, in some embodiments, one application (P2PNW) can have only one virtual leader. In some embodiments, a virtual leader 602.1, 602.8, and 602.11 may be called a group leader, header, controller, coordinator, master, manage, cluster leader, header, or zone leader. The peer 602 acting as a virtual leader or a sub-virtual leader may be dynamically changed to a different peer 602.

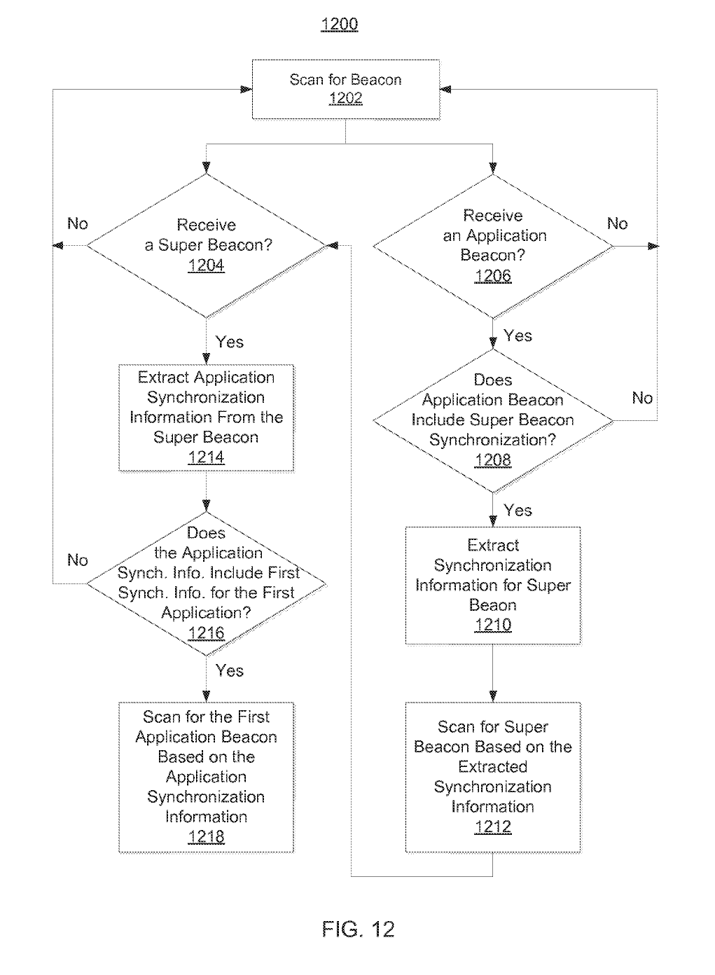

A sub-virtual leader 602.3 is a peer 602 defined to extend coverage through two or more hops based on the physical or logical topology for centralized intra-P2PNW control. The roles of a sub-virtual leader 602.3 may include managing a subgroup of peers 602.4, 602.5 with the same context-based service or application (P2PNW) (application A P2PNW 650) as the virtual leader 602.1 as a peer (i.e. a member) under the management of the virtual leader 602.1 and/or a sub-virtual leader (not illustrated) of the same group (P2PNW). The sub-virtual leader 602.3 may perform a subset of functions of the virtual leader 602.1. There may be sub virtual leaders (not illustrated) that are two hops from the virtual leader and that perform functions similar to the sub-virtual leader. The peers 602 may be configured to synchronize with one another according to methods disclosed in conjunction with FIG. 12.

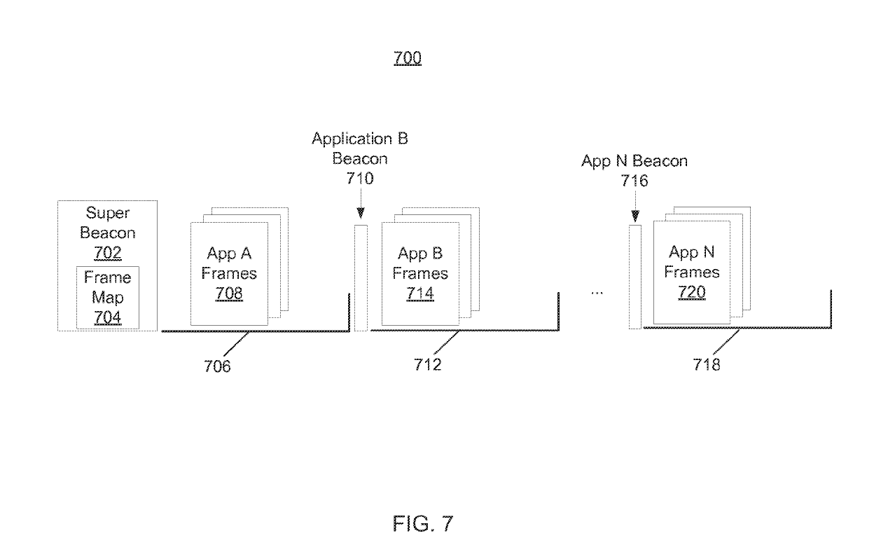

FIG. 7 illustrates an example of a super frame 700 according to some disclosed embodiments. Illustrated in FIG. 7 is a super frame 700 that includes a super beacon 702, application A frame time 706, application A frames 708, application B beacon frame 710, application B frame time 712, application B frames 714, application N beacon frame 716, application N frame time 718, application N frames 720. Application A 650 and application B 652 may refer back to FIG. 6. A common channel (not illustrated) may exist in every application frame 706, 712, 718.

The super beacon 702 may include frame map 704. The super beacon 702 may include a time reference (not illustrated). The super beacon 702 may indicate the start of a super frame 700. The super beacon 702 may also be an application A beacon. Application A frames 708 may follow the super beacon 702.

The frame map 704 may indicate timing information for scheduling the application frame times 706, 712, 718, and the common channel 707. Application B frame time 712 may begin with application B beacon frame 710 and be followed by application B frames 714. Application N frame time 718 may begin with application N beacon 716 and be followed by application N frames 720.

In some embodiments, the super frame 700 includes a common channel 707 that may be an unassigned channel in which peers 602 compete on a contentious basis. The common channel 707 may be used to communicate with the super virtual leader 602.1 (referring back to FIG. 6) to request or release channel resources. For example, a peer 602 may want to begin a new application C peer-to-peer network. The peer 602 may contend with other peers 602 to transmit during the common channel. The peer 602 may transmit a message during the common channel to the super virtual leader 602.1 requesting a time frame for application C.

The super beacon 702 may be sent by a super virtual leader 602.1. The super virtual leader 602.1 may be a virtual leader 602.1 for application A 650. The application B beacon 710 may be sent by a virtual leader 602.8 of application B 652. The application N beacon 716 may be sent by a virtual leader of application N (not illustrated in FIG. 6).

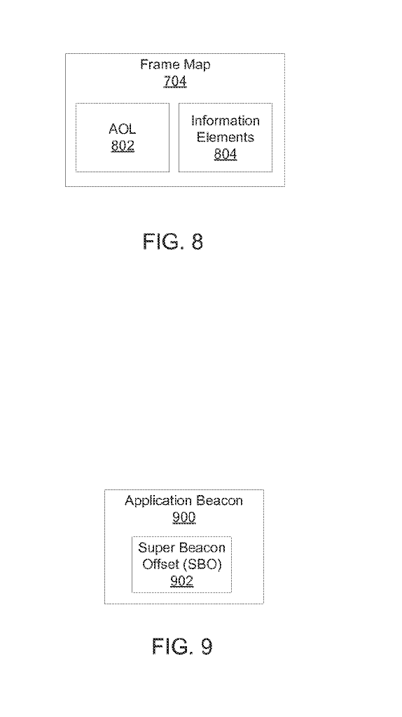

FIG. 8 illustrates an example of a frame map 704 according to some disclosed embodiments. The frame map 704 may include an application offset list (AOL) 802 and, optionally, one or more information elements 804.

The AOL 802 field may be synchronization information that indicates the time offset of the application frames 706, 712, and 718. For example, the super beacon 702 may include a time reference (not illustrated) and the AOL 802 may indicate the beginning of the application frames 706, 712, and 718 either as an absolute time or an offset to the time included with the super beacon 702. For example, the AOL 802 may indicate the beginning of the application frames 706, 712, and 718 by an offset from the time reference or by absolute time, or by slots or symbols from the beginning of the super beacon 1200. In some embodiments, the AOL 802 may not indicate some or all of the application frames 706, 712, 718 beginnings. The AOL 802 may not indicate some or all of the application frames 706, 712, 718 beginnings for security reasons. The information elements (IE) 804 may be for synchronization purposes.

FIG. 9 illustrates an example of an application beacon 900 according to some disclosed embodiments. The application beacon 900 may include a super beacon offset (SBO) 902. The SBO 902 may be synchronization information that indicates where the super beacon 902 begins. For example, the SBO 902 may indicate where the super beacon 902 begins by a time offset or a number of slots/symbols between the current application beacon 900 and the next super beacon 702. One skilled in the art will recognize that the SBO 902 may indicate in other ways when the next super beacon 702 will begin.

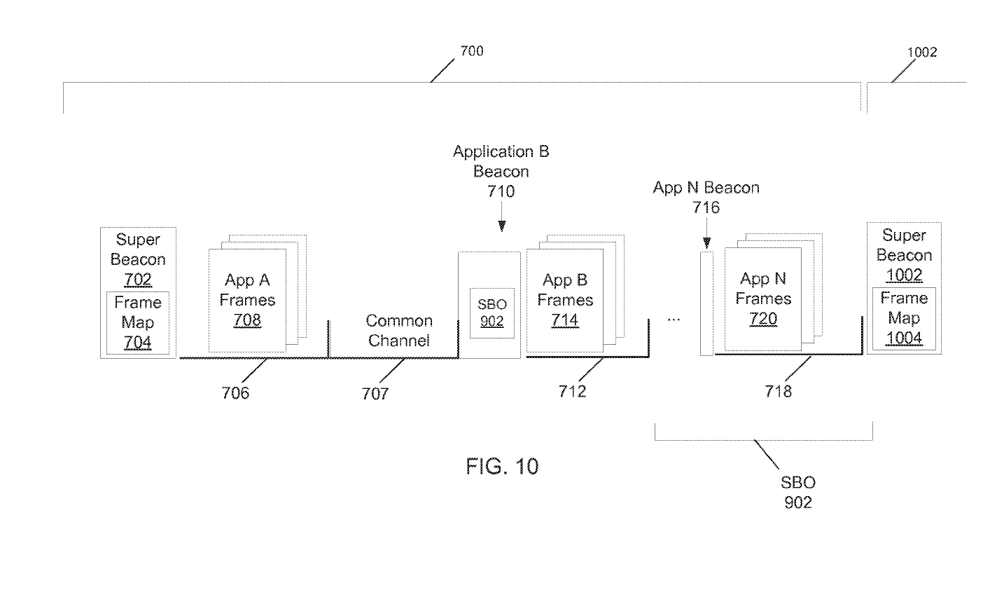

FIG. 10 illustrates an example of a super beacon offset (SBO) 902 according to some disclosed embodiments. Illustrated in FIG. 10 is a super frame 700 and next super frame 1002. Super frame 700 includes a super beacon 702, application A frame time 706, application A frames 708, application B beacon 710, application B frame time 712, application B frames 714, application N beacon 716, application N frame time 718, application N frames 720. Next super frame 702 includes super beacon 1002 with frame map 1004.

Application B beacon 710 may include SBO 902. The SBO 902 may indicate as illustrated in FIG. 10 when the next super beacon 1002 will occur. A peer 602 may scan the channel and listen for a super frame 702. The peer 602 may begin scanning after the super beacon 702 begins. The peer 602 may receive application B beacon 710 and use the SBO 902 to determine when the next super beacon 1002 will begin. Thus, the peer 602 may synchronize with the next super beacon 1002 by using the SBO 902.

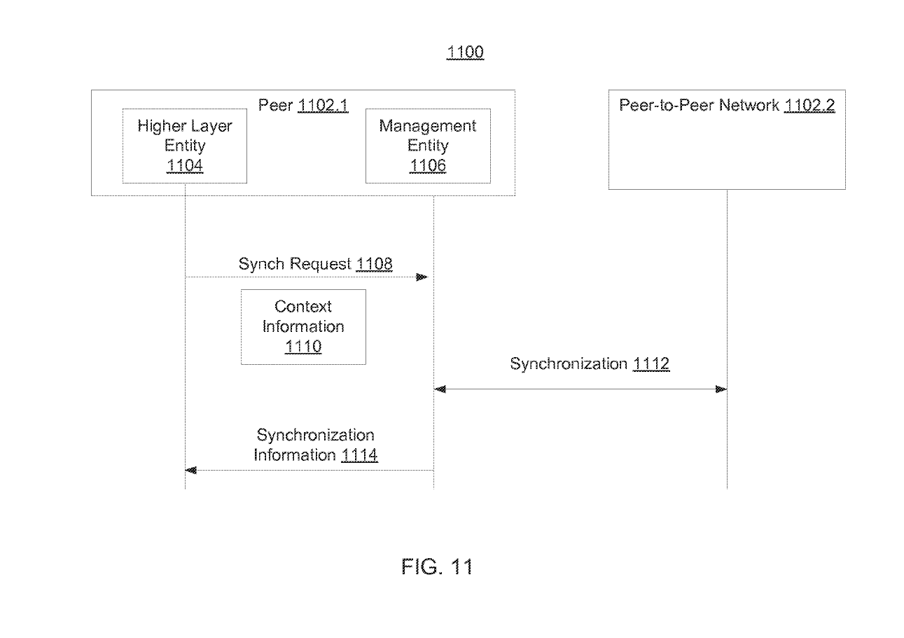

FIG. 11 illustrates an example of a method 1100 for context aware initial synchronization (CAIS). Illustrated in FIG. 11 is a peer 1102.1 and peer-to-peer network 1102.2. The peer 1102.1 may include higher layer entity 1104 and management entity 1106. The method 1100 may being with the higher layer entity 1104 sending a synchronization request 1108 that includes context information 1110 to the management entity 1106. For example, a social networking application may send a synchronization request to synchronize with a social networking application. The method 1100 may continue with the management entity 1106 synchronizing with the peer-to-peer network 1102.2 at 1112. For example, the management entity 1106 may synchronize with the social networking peer-to-peer network. FIG. 11 is an additional example where the management entity 1106 may be synchronizing with a first application, which may be the context information 1110. The method may continue with the management entity 1106 sending synchronization information 1114 to the higher layer entity 1104. For example, the management entity 1106 may send a time when the beacons of the social networking application will begin.

FIG. 12 illustrates an example of a method 1200 for context-aware synchronization for peer-to-peer communication according to some embodiments.

The method 1200 may begin with scanning for a beacon 1202. For example, a peer 602.10 (see FIG. 6) may scan for a beacon. In some embodiments, the method 1200 may include receiving context information 1110 which may be a specified application. In some embodiments, the specified application may be the common channel 707. The method 1200 may continue with receiving a super beacon 1204. For example, the peer 602.10 may determine whether or not the peer 602.10 has received a super beacon 702 (see FIG. 7.)

The method 1200 may, on the condition that a super beacon is received, extract synchronization information from the super beacon 1114. For example, the peer 602.10 may extract the frame map 704 from the super beacon 702. The method 1100 may continue with determining whether or not the synchronization information include information for the specified application 1216. For example, the frame map 704 may include the AOL 802 field which may indicate the time offset of the application frames 706, 712, and 718. The specified application may be application B 652, and the AOL field 802 may indicate an offset to application B beacon 710. In some embodiments, the specified application 1216 may be any of the context information 1110. In some embodiments, an application indicator (AI) is defined as the information indicating the criterion/result of whether or not the synchronization information includes information for the specified application at 1216.

If the synchronization information does not include information for the specified application, then the method 1200 may return to scanning for a beacon 1202. In some embodiments, the method 1200 may determine whether or not a time out for synchronization has occurred, and if it has occurred then the method 1200 may end.

If the synchronization information does include information for the specified application, then the method 1200 may continue with scanning for the application beacon for the specified application based on the synchronization information 1218. For example, continuing the example above, the peer 602.10 may scan for application B beacon 710 using the synchronization information from the frame map 704. The frame map 704 may include an offset for when application B beacon 710 may begin after the super beacon 702. As another example, as illustrated in FIG. 11, the management entity 1106 may pass the synchronization information 1114 to the higher layer entity 1104. The higher layer entity 1104 may then send another request to the management entity 1106 to scan for the application B beacon 710 using the synchronization information 1114.

The method 1200 may continue with peer 602 being synchronized with the specified application peer-to-peer network.

If a super beacon was not received at 1204, then the method may continue with determining whether an application beacon was received 1206. For example, a peer 602.10 may receive an application B beacon 710, which may be an application B beacon in the example of FIG. 6. The method 1200 may continue with determining whether or not the application beacon includes synchronization information for the super beacon 1208. For example, the peer 602.10 may have received application B beacon 710 which includes SBO 902. As another example, as illustrated in FIG. 11, the management entity 1106 may pass the synchronization information (determined time for next super beacon 1002) 1114 to the higher layer entity 1104. The higher layer entity 1104 may then send another request to the management entity 1106 to scan for the next super beacon 1002 using the synchronization information 1114.

The method 1200 may continue with scanning for the super beacon based on the extracted synchronization information 1212. For example, peer 602.10 may determine a time to scan for the next super beacon 1002 based on the SBO 902 (see FIG. 10), and then scan for the next super beacon 1002. In some embodiments, the method 1200 may continue with determining whether or not a super beacon was received 1204.

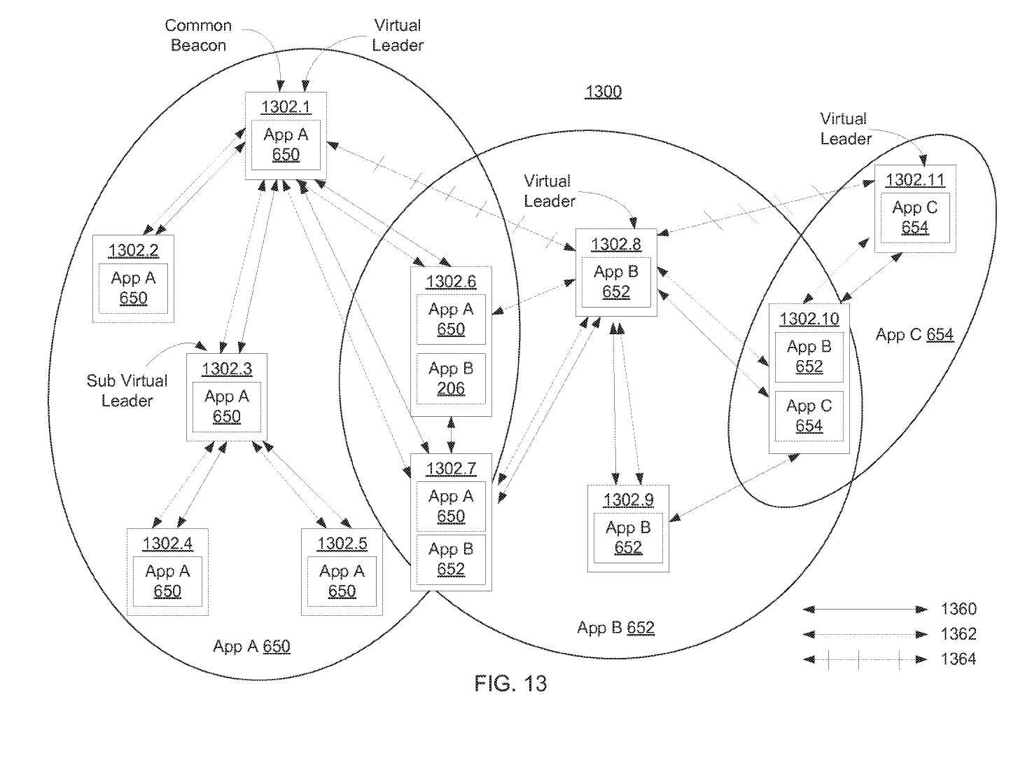

FIG. 13 illustrates an example of a peer to peer network (P2PNW) 1300 with hybrid control according to some disclosed embodiments. Illustrated in FIG. 13 are peers 1302, P2PNW for application A 650, P2PNW for application B 652, P2PNW for application C 654, data communication 1360, virtual leader control information 662, and common beacon control information 1364.

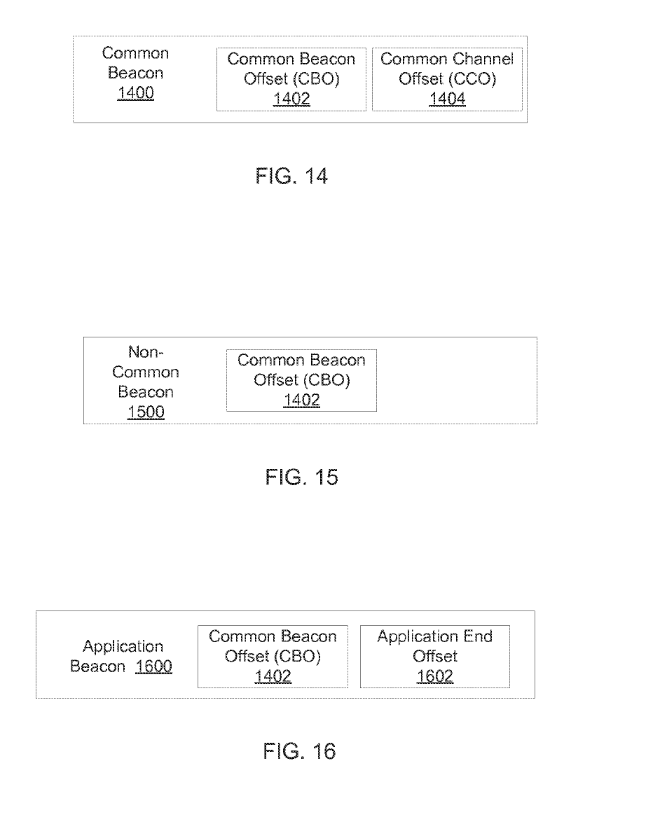

Peer 1302.1 may be configured to send the common beacon (CB) 1400 (see FIG. 14) and to be the virtual leader of P2PNW application A 650. Peer 1302.3 may be configured to be a sub virtual leader of P2PNW of application A 650. Peer 1302.8 may be configured to be a virtual leader of P2PNW application B 652. Peer 1302.11 may be configured to be a virtual leader of P2PNW application C 654.

The peers 1302 may be configured to use a common channel to maintain the same time reference for different virtual leaders 1302.1, 1302.3, 1302.8, 1302.11 so that the frames of different applications 650, 652, 654 do not overlap with each other.

The CB 1302.1 may be configured to provide a time reference common channel offset 1404 for the common channel in the common beacon 1400. The peers 1302 may be configured to include a common beacon offset 1402 in their beacons 1500. The peers 1302 may be configured to include an application end offset 1602 in their beacons which may be used by other peers 1302 to determine how long the application frame is.

The peers 1302 may be configured to synchronize with the virtual leaders 1302.1, 1302.3, 1302.8, and 1302.11 of the P2PNW of application A 650, P2PNW application B 652, or P2PNW of application C 654 according to the application 650, 652, 654 the peer 1302 is running. If a peer 1302 cannot synchronize with a virtual leader 1302.1, 1302.3, 1302.8, and 1302.11, the peer 1302 may synchronize with the common channel.

Peers 1302 may be configured to unicast to another peer 1302, to multicast to two or more peers 1302, or to broadcast to peers 1302.

The virtual leaders 1302.1, 1302.8, and 1302.11 may be configured to manage control related communications directly or through sub virtual leaders 1302.3 to manage P2PNWs application A 650, application B 652, and application C 654, respectively. A virtual leader 1302.1, 1302.8, and 1302.11 is a peer 1302 defined to represent, manage, and coordinate the P2P communications among a group of peers 602 sharing the same context-based service or application, i.e. within a P2PNW, for centralized intra-P2PNW control. A virtual leader 1302.1, 1302.8, and 1302.11 may be dynamically determined and/or changed within the group (P2PNW). A virtual leader 1302.1, 1302.8, and 1302.11 may perform one or more of the following functions for the group (P2PNW): context management, context-aware discovery broadcast, context-aware peer association, group membership management, synchronization, link management, channel allocation and accessing control, reliable data transmission, routing management, power control and interference management, and channel measurement coordination. In some embodiments, a peer 1302 may only be the virtual leader 1302.1, 1302.8, and 1302.11 for one application (P2PNW), and, in some embodiments, one application (P2PNW) can have only one virtual leader. In some embodiments, a virtual leader 1302.1, 1302.8, and 1302.11 may be called a group leader, header, controller, coordinator, master, manage, cluster leader, header, or zone leader.

A sub-virtual leader 1302.3 is a peer 1302 defined to extend coverage through one or more hops based on the physical or logical topology for centralized intra-P2PNW control. The roles of a sub-virtual leader 1302.3 may include managing a subgroup of peers 1302.4, 1302.5 with the same context-based service or application (P2PNW) (application A P2PNW 650) as the virtual leader 1302.1 as a peer (i.e. a member) under the management of the virtual leader 1302.1 and/or a sub-virtual leader (not illustrated) of the same group (P2PNW). The sub-virtual leader 1302.3 may perform a subset of functions of the virtual leader 1302.1. There may be sub sub virtual leaders (not illustrated) that are two hops from the virtual leader and that perform functions similar to the sub-virtual leader.

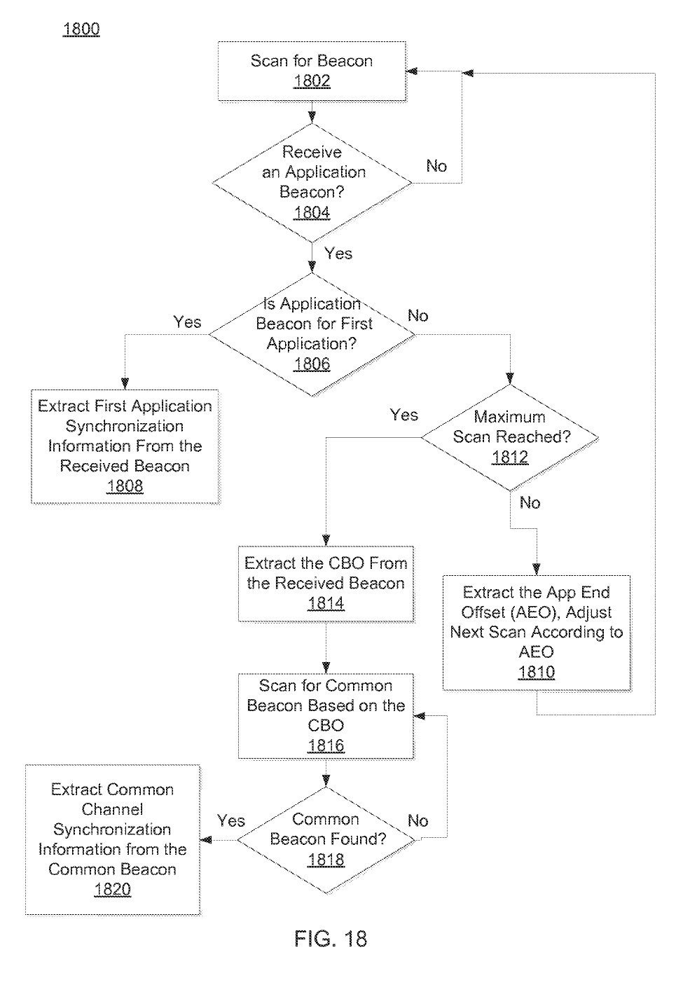

The peers 1302 may be configured to synchronize with one another according to the method disclosed in FIG. 18.

FIG. 14 illustrates an example of a common beacon (CB) 1400 according to some disclosed embodiments. Illustrated in FIG. 14 is a common beacon 1400 which may include a common beacon offset (CBO) 1402, and a common channel offset (CCO). In some embodiments, the common beacon 1400 may include an application end offset 1602 (FIG. 16). The CBO 1402 may be synchronization information to enable a peer to synchronize with the common beacon 1400. For example, the CBO 1402 may indicate where the common beacon 1400 begins by a time offset or a number of slots/symbols between the application beacon that includes the CBO 1402 and the next common beacon 1400. One skilled in the art will recognize that the CBO 1402 may indicate in other ways when the next common beacon 1400 will begin.

The CBO 1402 may be zero when the CBO 1402 is included with the common beacon 1400. The common channel offset 1404 may be synchronization information to enable a peer to synchronize with the common channel.

FIG. 15 illustrates an example of a non-common beacon 1500 according to some disclosed embodiments. The non-common beacon 1500 may include a common beacon offset (CBO) 1402 as disclosed in conjunction with FIG. 14.

FIG. 16 illustrates an example of an application beacon 1600 according to some disclosed embodiments. The application beacon 1600 may include a common beacon offset (CBO) 1402 and an application end offset (AEO) 1602. The application end offset 1602 may indicate the length of the application frame time. For example, the AEO 1602 may indicate where the application frame ends by a time offset or a number of slots/symbols between the application beacon 1600 that includes the AEO 1602 and the end of the application frame. One skilled in the art will recognize that the AEO 1602 may indicate in other ways when the application frame will end.

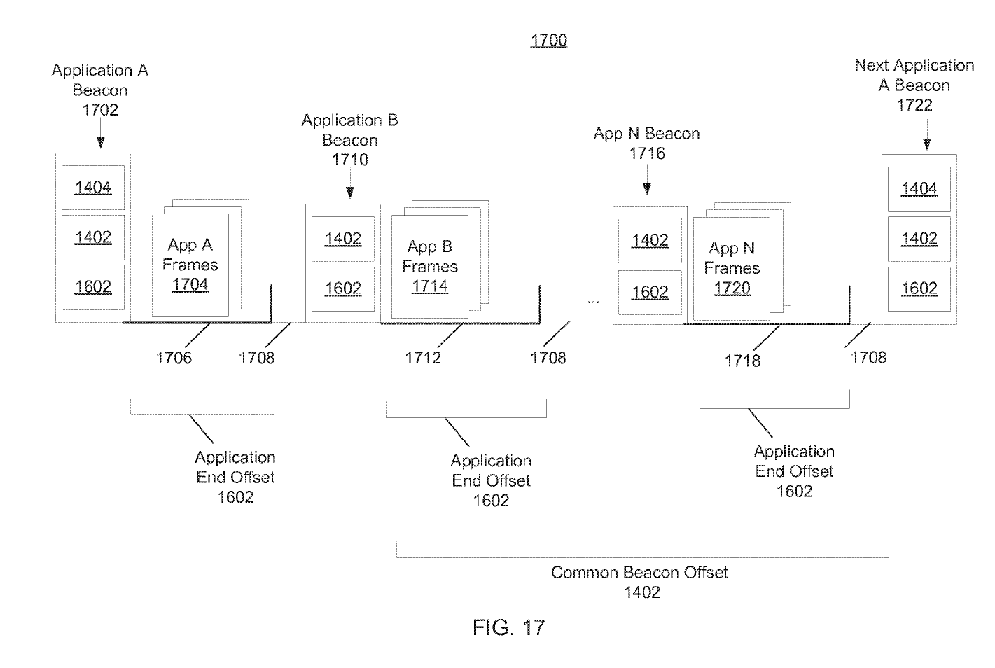

FIG. 17 illustrates an example of a super frame 1700 according to some disclosed embodiments. The super frame 1700 may include application A beacon 1702, application A time 1706, application A frames 1704, guard intervals 1708, application B beacon 1710, application B time 1712, application B frames 1714, application end offsets 1602, application N beacon 1716, application N time 1718, and application N frames 1720. Application A beacon 1702 may include CBO 1402, CCO 1404, and AEO 1602. Application A beacon 1702 is a common beacon 1400. For example, peer 1602.1 may transmit application A beacon 1702. The AEO 1602 indicates when the application A time will end. Peers 1602 may be configured to use this to determine when to scan for a next beacon or the common channel (not illustrated).

The CBO 1402 indicates when the next CB 1400 will be transmitted. The CBO 1402 for the application A beacon 1702 may be zero to indicate that the application A beacon 1702 is a CB 1400. The common beacon offset 1402 of application B beacon 1710 may indicate when the next common beacon will be, which in this case is the next application A beacon 1722 is. The common channel offset 1404 may indicate when the next common channel (not illustrated) is.

FIG. 18 illustrates an example of a method 1800 for context-aware synchronization for peer-to-peer communication according to some embodiments.

The method 1800 may begin with scanning for a beacon 1802. For example, a peer 1302.10 (see FIG. 13) may scan for a beacon. In some embodiments, the method 1300 may include receiving context information 1110 which may be a specified application, which may be called a first application or application indicator. An application indicator may be indicator that indicates which application to synchronize with. For example, in FIG. 13 there are three applications application A 650, application B 652, and application C 654. In some embodiments, the specified application may be the common channel.

The method 1800 may continue with determining whether or not an application beacon was received 1804. If an application beacon was not received, the method 1800 may return to scanning for a beacon 1802. In some embodiments, a maximum beacon scan time may be checked before returning to scanning for a beacon 1802. If a maximum scan time has been reached one or more parameters may be reset.

If an application beacon is received, then the method may continue with determining whether or not the received application beacon is for a first application 1806. The first application may be, for example, P2PNW application B 652 of FIG. 13. If the received beacon is for the first application, then the method may continue with extracting first application synchronization information from the received beacon 1808. For example, if the received beacon is application B beacon 1710 of FIG. 17, then AEO 1602 may be extracted to synchronize with P2PNW application B 652. The extracted information may include other information that determines when a next application B beacon 1710 will be transmitted. In some embodiments, the method 1800 may continue with returning the first application synchronization information to a higher layer entity 1104 (FIG. 11).

If the application beacon is determined not to for a first application, then the method may continue with determining whether or not a maximum scan has been reached 1812. If the maximum scan has not been reached, then the method continues with extracting the application end offset (AEO) and adjusting the next scan according to the 1810. For example, referring to FIG. 17, if the received beacon were application B beacon 1710 and the first application was not application B, then then AEO 1602 may be extracted to determine when application B time 1712 ends so that the scanning does not occur for the application B frames 1714. The method 1800 man then return to scanning for beacon 1802.

If the maximum scan has been reached, then the method 1800 may continue with extracting the CBO from the received beacon 1814. For example, continuing with the example above, the CBO 1402 may be extracted from application B beacon 1710. The method 1800 may continue scanning for the common beacon based on the CBO 1816. For example, continuing with the example above example, scanning may not be performed for a period of time approximately equal to the CBO 1402, and then scanning may continue. As illustrated in FIG. 17, the scanning may continue after waiting CBO 1402 time and then the scanning may scan next application A beacon 1722, which is a common beacon 1400.

The method 1800 may continue with determining whether or not the common beacon was found 1818. If the common beacon was not found, then the method 1800 may return to scanning for the common beacon based on the CBO 1816. In some embodiments, parameters may be reset before returning to 1816, and in some embodiments the method may determine to return to another set or abort the method if the common beacon cannot be found.

If the common beacon is found, then the method may continue with extracting common channel synchronization information form the common beacon 1820. Continuing with the example of FIG. 17, the common channel offset 1404 may be extracted from the next application A beacon 1722. When the common channel (not illustrated) is next may then be based on the common channel offset 1400. In some embodiments, the method 1800 may continue with returning the common channel offset 1400 to a higher layer entity 1104 (FIG. 11).

In some embodiments, a maximum time may be exceeded or a maximum number of times may be exceeded whereby the method 1800 may return to a higher layer entity 1104 an error indication or an indication that a beacon with the context information 1110 could not be determined and which may indicate that synchronization information for the common channel could not be determined.

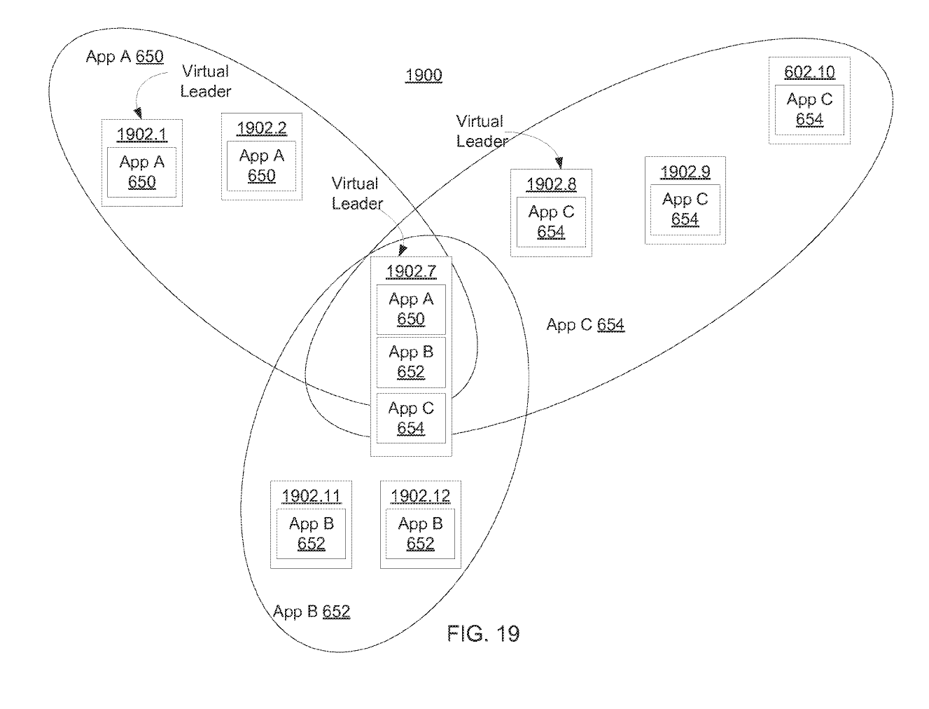

FIG. 19 illustrates an example of a peer to peer network (P2PNW) 1900 according to some disclosed embodiments.

Illustrated in FIG. 19 are peers 1902, P2PNW for application A 650, P2PNW for application B 652, P2PNW for application C 654. The P2PNWs 650, 652, 654 may be synchronized by different control methods. For example, the P2PNWs 650, 652, 654 may be synchronized using the hybrid methods described in conjunction with FIG. 18, or by using the centralized method disclosed in conjunction with FIG. 12.

Peer 1902.1 may be configured to be a virtual leader of P2PNW application A 650. Peer 1902.7 may be configured to be a virtual leader of P2PNW application B 652. Peer 1902.8 may be configured to be a virtual leader of P2PNW application C 654. The peers 1902 may need to synchronize with one another.

Peers 1902 may have multiple active applications 650, 652, 654 simultaneously. For example, peer 1902.7 has application A 650, application B 652, and application C 654 active simultaneously. The peers 1902 may be configured to perform synchronization according to the method disclosed in conjunction with FIG. 21. In some embodiments, the virtual leaders 1902.1, 1902.7, and 1902.8 are configured to perform the synchronization disclosed in conjunction with FIG. 21.

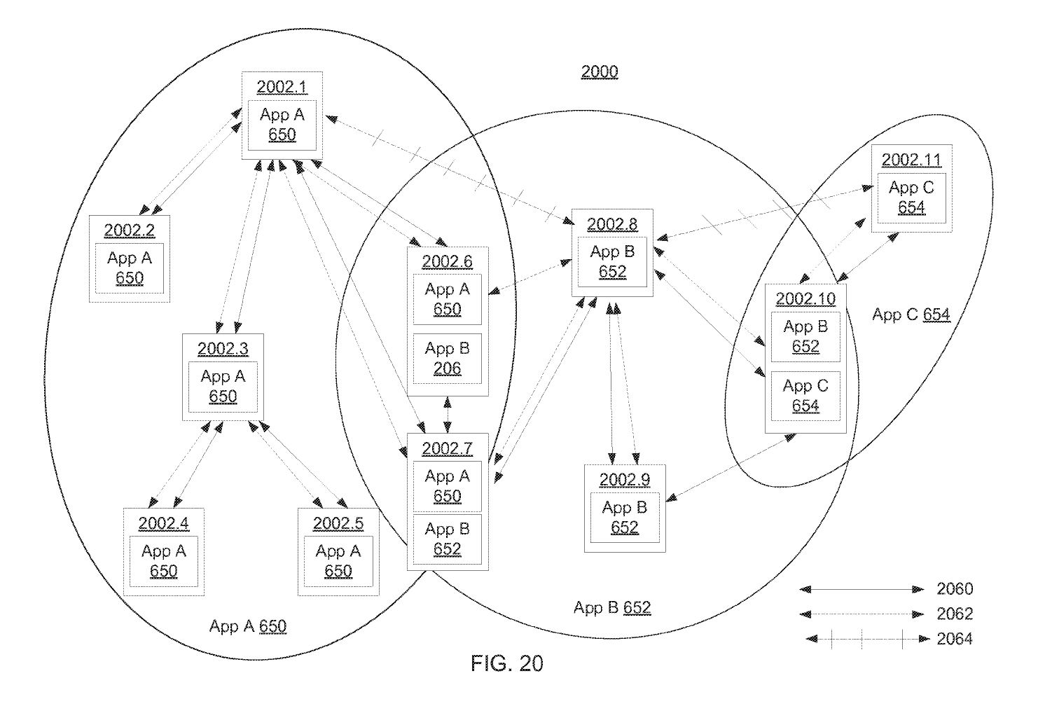

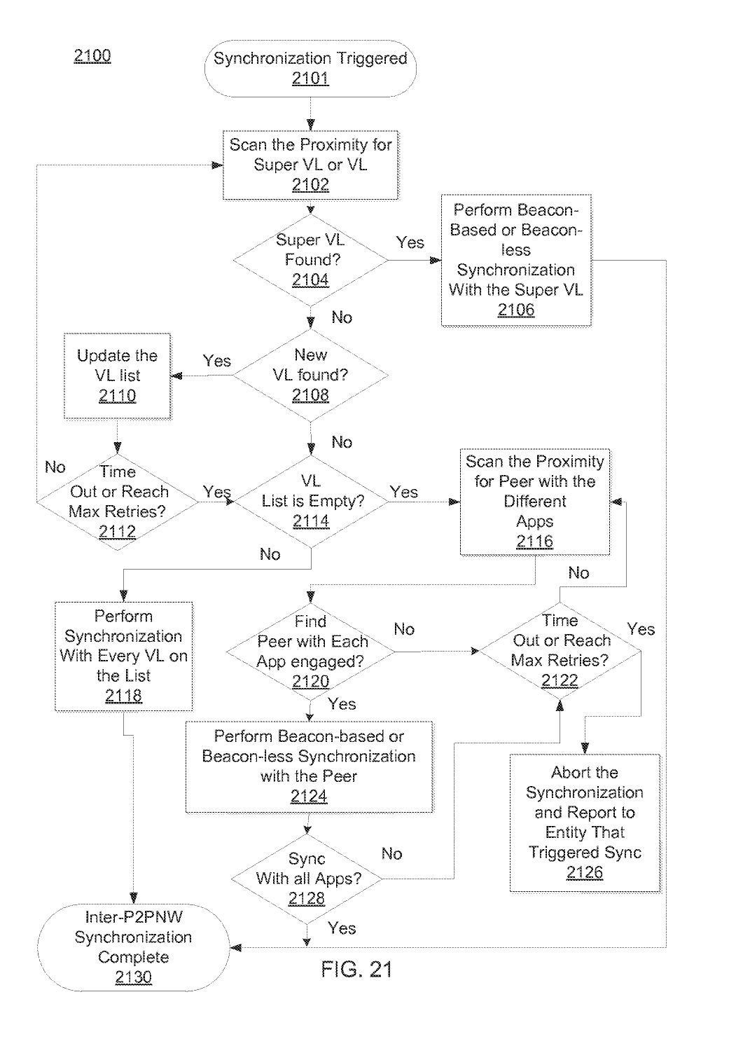

FIG. 20 illustrates an example of a peer to peer network (P2PNW) 2000 with distributed control according to some disclosed embodiments.

Illustrated in FIG. 20 are peers 2002, P2PNW for application A 650, P2PNW for application B 652, P2PNW for application C 654, data communication 2060, intra P2PNW control information 2062, and inter P2PNW control information 664.

A peer 2002 manages its control related communications when communicating with other peers 2002 within a P2PNW 650, 652, 654. For example, Peer 2002.8 of application B P2PNW 652 may handle intra P2PNW control information 2062 with other peers 2002 in the application B P2PNW 652 such as peer 2002.6, 2002.7, 2002.9, and 2002.10. There may be no virtual leader, sub virtual leader, or super virtual leader acting as a central controller.

A peer 2002 may manage inter P2PNW 650, 652, 654, communication to control related communications with other peers 2002 outside of the P2PNW of the peer 2002. For example, peer 2002.8 may manage inter P2PNW communication with inter P2PNW control information 2064.

Peers 2002 may have multiple active applications 650, 652, 654 simultaneously. For example, peer 2002.6 has application A 650 and application B 652 active simultaneously. The peers 2002 may be configured to perform synchronization according to the method disclosed in conjunction with FIG. 21 and/or other methods disclosed herein.

FIG. 21 illustrates an example of an inter-P2PNW synchronization according to some disclosed embodiments.

The method 2100 may begin with synchronization being triggered 2101. The synchronization may be triggered by a peer 1902. The synchronization may be triggered by a higher layer entity 308 to a management entity 308 (see FIG. 4). The synchronization may be triggered as part of a higher layer, peer discovery, peer association, or a new application being run on the peer 1902. For example, peer 1902.8 may run application B 652.

The method 2100 may continue with scanning for a super virtual leader of or a virtual leader in the proximity 2102. For example, a peer 1902 may scan for a beacons or transmit a polling message. The method 2100 may continue with determining whether or not a super virtual leader was found 2104. If a super virtual leader was found, the method 2100 continues with perform beacon-based or beacon-less synchronization with a super virtual leader 2106. For example, referring to FIG. 6, peer 602.6 may scan for a virtual super leader and find peer 602.1 by receiving the super beacon 702. The peer 602.6 may then synchronize with the super virtual leader according to the method disclosed in conjunction with FIG. 12.

The method 2100 would then end with inter-P2PNW synchronization complete 2030.

If a super VL was not found at 2104, then the method 2100 continues with determining whether or not a new virtual leader found 2108. For example, a peer 1902 may keep a list of virtual leaders that peer 1902 is aware of, and the peer 1902 may synchronize with all the virtual leaders in the list.

If the virtual leader was a new virtual leader, then the method 2100 continues with updating the virtual leader list 2110. For example, the peer 1902 may update a list of virtual leaders with the new virtual leader.

The method 2100 then continues with determining whether or not a a time out has been reached or whether or not a maximum number of retries has been reached 2112. If a time out has not been reached and the maximum number of retries has not been reached, then the method 2100 may continue with returning to scanning the proximity for a super virtual leader or a virtual leader 2102.

If a time out has been reached or a maximum number of retries has been reached, then the method 2100 may continue with determining whether or not the virtual leader list is empty 2114. If the virtual leader list is not empty, then the method 2100 continues with performing synchronization with every virtual leader on the list 2118. The peer 1902 may synchronize with every virtual leader on the list using one of the methods for synchronization disclosed herein such as the method disclosed in conjunction with FIG. 18. The method 2100 may then end with inter-P2PNW synchronization complete 2130.

If the virtual leader list is empty at 2114, then the method 2100 continues with scanning the proximity for peers with different applications 2116. For example, referring to FIG. 20, peer 2002.8 may scan for peers 2002 with different applications than application B 652.

The method 2100 may continue with determining whether or not one or more peers were found with a different applications 2120. If one or more peers were found with different applications, then the method 2100 continues with performing beacon-based or beacon-less synchronization with the found peers 2124. For example, peer 2002.8 may have found peer 2002.1 with application A 650 and peer 2002.11 with application C 654. Peer 2002.8 may perform beacon based or beacon-less synchronization with peer 2002.1 and peer 2002.11.

The method 2100 may continue with determining whether or not the peer is synchronized with all the applications in the proximity of the peer 2128. If the peer is synchronized with all the applications in the proximity of the peer, then the method 2100 may end with inter-P2PNW synchronization complete 2130.

If the application is not synchronized with all the applications in the proximity of the peer, or if a peer has not been found for each application in the proximity of the peer, then the method 2100 may continue with determining whether a time out or a maximum number of retries has been reached 2122.

If a time out has been reached or a maximum number of retries has been reached, then the method 2100 may continue with aborting the synchronization and reporting to the entity that triggered the synchronization that its synchronization has failed 2126.

If a time out has not been reached and a maximum number of retries has not been reached, then the method 2100 may return to scanning the proximity for peers with different applications 2116.

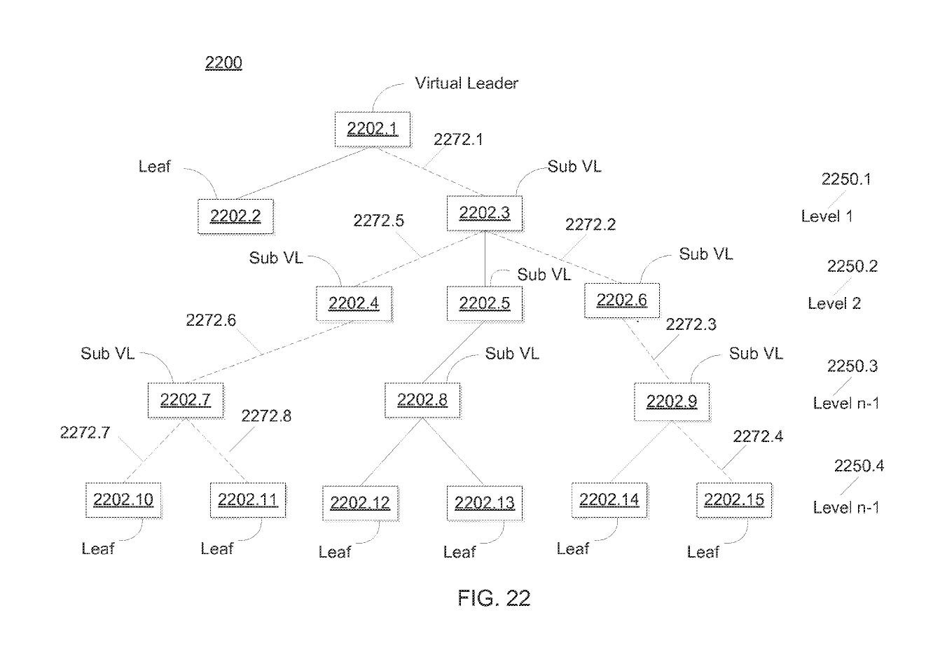

FIG. 22 illustrates an example of a tree structure 2200 illustrating a multi-hop peer-to-peer network where beacons are used for synchronization.

Illustrated in FIG. 22 are peer 2202, synchronization paths 2272, and levels 2250. Peer 2202.1 may be a virtual leader. Peers 2202.3, 2202.4, 2202.5, 2202.6, 2202.7, 2202.8, 2202.9 may be sub virtual leaders. Peer 2202.2, 2202.10, 2202.11, 2202.12, 2202.13, 2202.14, and 2202.15 may be leafs. A peer 2202 may be on a level 2250 of the tree structure 2200.

The peers 2202 may be part of a centrally controlled P2PNW such as the P2PNW illustrated in FIG. 6. The peers 2202 may only exchange data with a virtual leader either through one hop or through multiple hops. For example, peer 2202.2 may exchange data with peer 2202.3 through peer 2202.1, which is a virtual leader.

A beacon for synchronization may be periodically sent by the virtual leader, which here is peer 2202.1. For more than one hop away the beacon messages are forwarded by sub virtual leaders (VL). For example, the virtual leader, which is peer 2202.1, sends a beacon message (not illustrated), which is received by peers 2202.2 and 2202.3. Peer 2202.3, which is a sub VL, re-transmits the beacon message that is received by peers 2202.4, 2202.5, 2202.6, each of which re-transmits the beacon message because they are each sub VLs. The sub VL may be configured to relay the beacon messages. A peer 2202 at level n−1 2250.3 synchronizes with a peer 2202 at level n 2250.2. Each peer 2202 synchronizes with either the virtual leader or a sub virtual leader. The sub virtual leaders may receive the beacon and insert the time information in the beacon and then forward the beacon to the next levels.

For example, peer 2202.10, which is a leaf node, receives the beacon from peer 2202.1, which is the virtual leader in the following way. First peer 2202.1 transmits the beacon. The beacon follows synchronization path 2272.1. Peer 2202.3 receives the beacon and inserts the time information in the beacon and then relays the beacon. The beacon follows synchronization path 2272.5 and is received by peer 2202.4. Peer 2202.4 inserts the time information in the beacon and then relays the beacon. The beacon follows synchronization path 2272.6 and is received by peer 2202.7. Peer 2202.7 inserts the time information in the beacon and relays it. The beacon follows synchronization path 2272.7 and 2272.8. Peers 2202.10 and 2202.11 then receive the beacon after 4 hops. The tree structure 2220 may be a result of peer discovery or association. The tree structure 2200 may be dynamic. The virtual leader may be configured to construct the tree structure 2200 and maintain a dynamic copy of the tree structure.

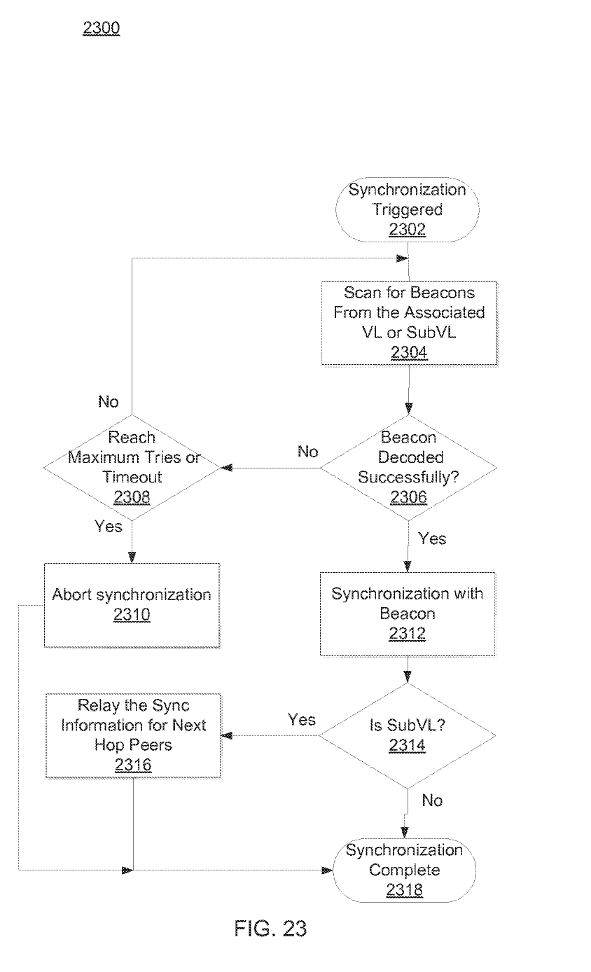

FIG. 23 illustrates an example of a method for beacon based synchronization for centralized P2PNWs.

The method may begin with synchronization trigger 2302. For example, the synchronization may be trigger by a peer 2202. The synchronization may be triggered by a higher layer entity 308 to a management entity 308 (see FIG. 4). The synchronization may be triggered as part of a higher layer, peer discovery, peer association, or a new application being run on the peer 2202.

The method 2300 may continue with scanning for beacons from the associated virtual leader or sub virtual leader 2304. For example, peer 2202.7 may scan for beacons from peer 2202.4, which is a sub virtual leader. As another example, peer 2202.3 may scan for a beacon from peer 2202.1 which is a virtual leader.

The method 2300 may continue with determining whether the beacon was decoded successfully 2306. If the beacon was not decoded successfully then the method 2300 may continue with determining whether or not a maximum number of retries has been reached or whether a timeout has expired 2308. If the maximum number of retries has not been reached and the timeout has not expired, then the method 2300 continues by returning to scanning for beacons from the associated VL or sub VL 2304.

If the maximum number of retries has been reached or the timeout has been reached, then the method 2300 continues with abort synchronization 2310. The method 2300 may abort and report failure to synchronize to a higher layer. The method 2300 then continues to synchronization complete 2317.

If the beacon was decoded successfully at 2306, then the method 2300 continues with synchronizing with the beacon 2312. The method 2300 may continue with determining whether or not the peer is a sub virtual leader or not 2314. If the peer is not a sub virtual leader, then the method 2300 continues with synchronization complete 2300 where it may be reported to a higher layer entity that the synchronization was complete. As example, if peer 2202.10 receives the beacon, then the peer 2202.10 may simple synchronize with the beacon and not relay the beacon since the peer 2202.10 is a leaf.

If the peer is a sub virtual leader at 2314, then the method continues with relaying the synchronization information for the next hop peers 2316. For example, peer 2202.7 is a sub virtual leader, so when it receives a beacon it puts in the timing information and then relays the beacon so that peers 2202.10 and 2202.11 can receive the beacon. The method 2300 may continue with synchronization complete 2318. It may be reported to a higher layer that the synchronization was successful.

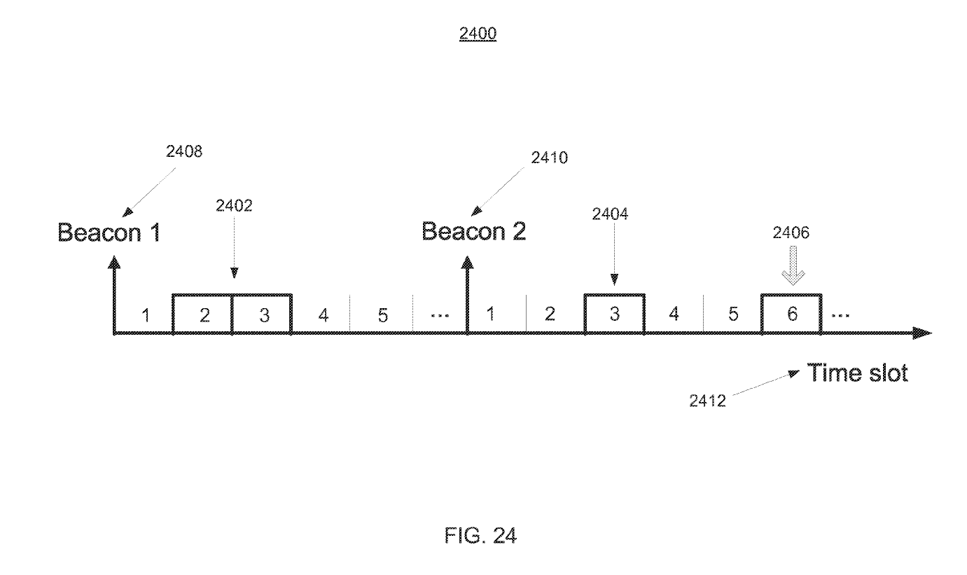

FIG. 24 illustrates an example of a beacon of a virtual leader with reserved time slots.

Illustrated in FIG. 24 is beacon 1 2408, beacon 2 2410, reserved time slots 2402, allocated time slot 2404, and allocated time slot 2406. Time slots 2412 are illustrated along the horizontal axis. Beacon 1 2408 and beacon 2 2410 may be transmitted by a virtual leader. For example, peer 2202.1 may have transmitted the beacon 1 2408 and then beacon 2 2410. The virtual leader may be configured to reserve time slots for delay sensitive messages. The virtual leader indicates the reservation of times slots with information in the beacon 1 2408, beacon 2 2410. For example, beacon 1 2408 may indicate that reserved time slots 2402 are reserved for delay sensitive messages. Because the reserved time slots 2402 are not specifically allocated to a peer, a peer underneath the virtual leader may contend to transmit during the reserved time slots 2402. Peers higher on the synchronization tree 2200 will have an earlier chance to use the reserve time slots 2402 since the peers higher on the synchronization tree 2200 will examine beacon 1 2408 before peers 2202 lower on the synchronization tree 2220. The reserve time slots 2402 may be used by virtual leaders and sub virtual leaders for synchronization purposes to enable faster synchronization. Peers 2202 may use the reserve time slots 2402 for emergency or time critical messages.

The virtual leader may also be configured to allocate some allocated time slots 2404, 2406 for sub virtual leaders to re-transmit the beacon of the virtual leader. The virtual leader may be configured to determine how many allocated time slots 2404, 2406 are needed for a tree structure 2200 which the virtual leader may maintain. For example, a sub virtual leader may receive beacon 2 2410 and then insert time information in beacon 2 2410 and retransmit beacon 2 2410 at allocated time slot 2404 and/or allocated slot 2406.

The methods and beacon of using reserved slots 2402, 2404, and 2406 for retransmitting the virtual leader beacon and/or for providing an open slot that may be used by a peer on a contentious basis may be termed dynamic relay methods.

If a virtual leader or sub virtual leader activates the dynamic relay methods, then the virtual leader and/or sub virtual leader may be configured to send an enhanced beacon with some additional information such as more accurate time information and/or a special synchronization header that will be used in data message to help peers to do the initial synchronization or more accurate synchronization.

If a peer or sub virtual leader accesses the reserved or allocated time slot, then the peer or sub virtual leader may insert a pre-defined sequence along with delay sensitive message for synchronization.

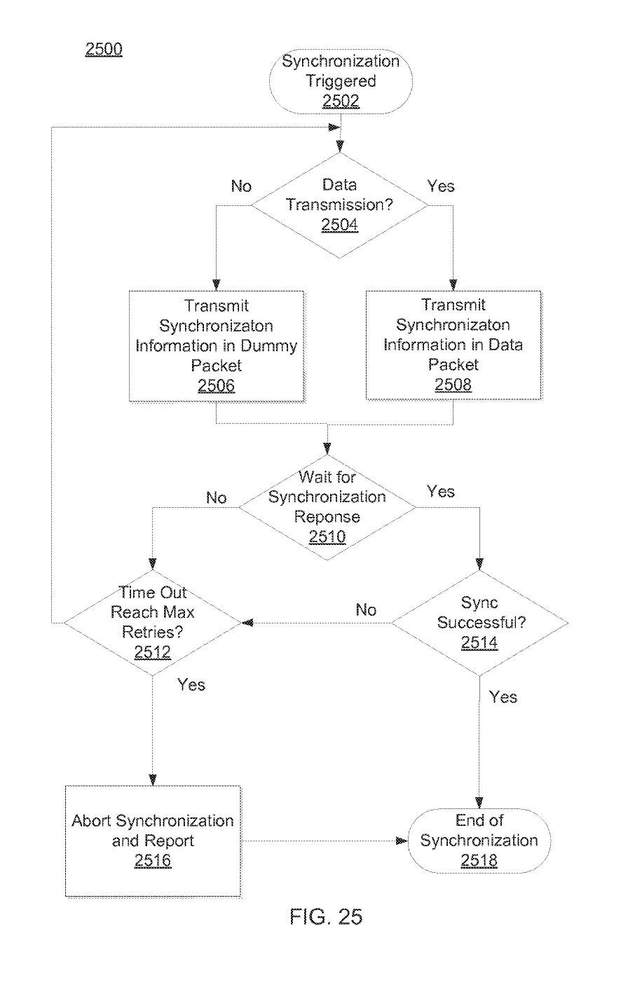

FIG. 25 illustrates an example of a method 2500 of beacon-less synchronization for a virtual leader and/or sub virtual leader with centralized communication.

The method may begin with synchronization trigger 2502. For example, the synchronization may be triggered by a peer 2202. The synchronization may be triggered by a higher layer entity 308 to a management entity 308 (see FIG. 4). The synchronization may be triggered as part of a higher layer, peer discovery, peer association, or a new application being run on the peer 2202.

The method 2500 may continue with determining whether or not there is a data transmission to be sent 2504. If a data transmission is to be sent, then the method 2500 continues with transmitting synchronization information in a data packet 2508. Otherwise, the method 2500 continues with transmitting synchronization information in a dummy packet. The method 2500 in both cases then continues with waiting for a synchronization response 2510. If a synchronization response is not received, then the method 2500 continues with determining whether or not a time out has occurred or whether or not a maximum number of retries has occurred 2512. If a timeout has occurred or a maximum number of retries has occurred, then the method continues with aborting the synchronization and reporting the aborting 2516. For example, it may be reported to a higher layer entity that synchronization failed. The method 2500 then continues to end of synchronization 2518.

If a timeout did not occur and a maximum number of retries was not reached at 2512, then the method returns to determining whether or not there is a data transmission to be sent 2504.

If the synchronization was successful at 2514, then the method 2500 continues with end of synchronization 2518 where it may be reported to a higher layer entity that the synchronization was successful. The virtual leaders and sub virtual leaders disclosed herein may be configured to perform the method 2500.

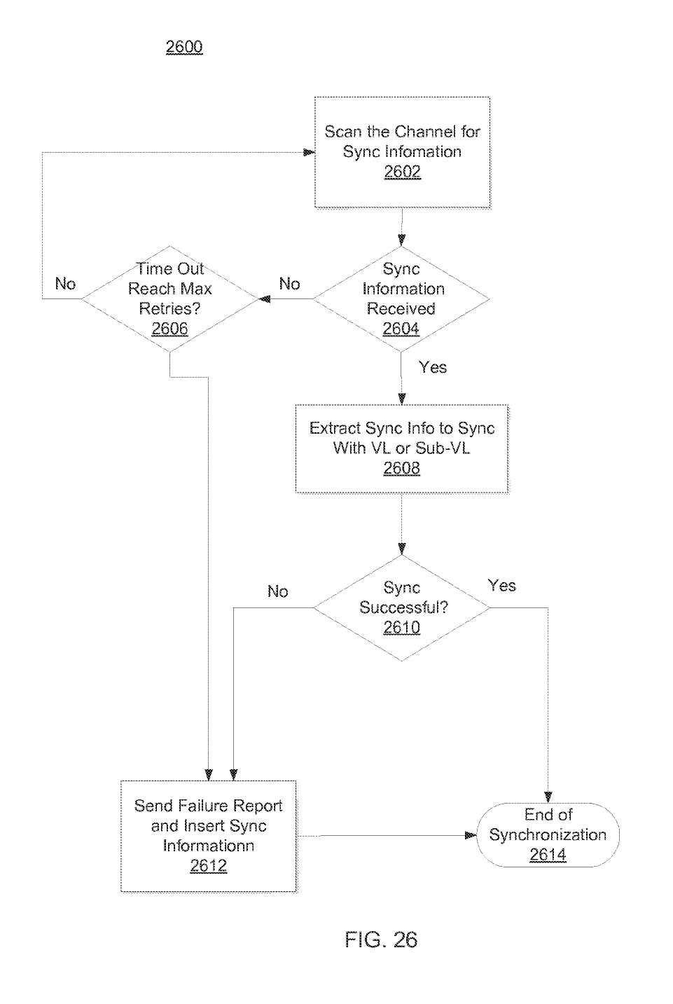

FIG. 26 illustrates an example of a method 2600 of beacon-less synchronization for a peer that is not acting as a virtual leader or a sub virtual leader with centralized communication. The method 2600 may begin with scanning the channel for synchronization information 2602. The method 2600 may continue with determining whether or not synchronization information was received 2604. If synchronization information was not received, then then the method 2600 continues with determining whether or not a time out has occurred or whether or not a maximum number of retries has occurred 2606. If a timeout has occurred or a maximum number of retries has occurred, then the method continues with sending a failure report and inserting synchronization information 2612. For example, it may be reported to a higher layer entity that synchronization failed.

If a time out did not occur and a maximum number of retries was not reached, then the method 2600 may continue with returning to scanning the channel for synchronization information 2602.

If synchronization was received at 2604, then the method 2600 continues with extracting the synchronization information to synchronize with a virtual leader or sub virtual leader 2608. For example, a peer may synchronize with a virtual leader or sub virtual leader according to one of the methods disclosed herein. The method 2600 may continue determining whether or not the synchronization was successful 2610. If the synchronization was not successful, then the method 2600 may continue on to sending a failure report and inserting synchronization information 2612 as discussed above. If the synchronization was successful at 2610, then the method 2600 may continue with ending of the synchronization 2614 where the success may be reported to a higher layer. In some embodiments, if the synchronization is not successful at 2610, the method 2600 may continue to determining whether or not a time out occurred or a maximum number of retries was reached 2606 as discussed above.

Peers disclosed herein may be configured to perform the method of 2600.

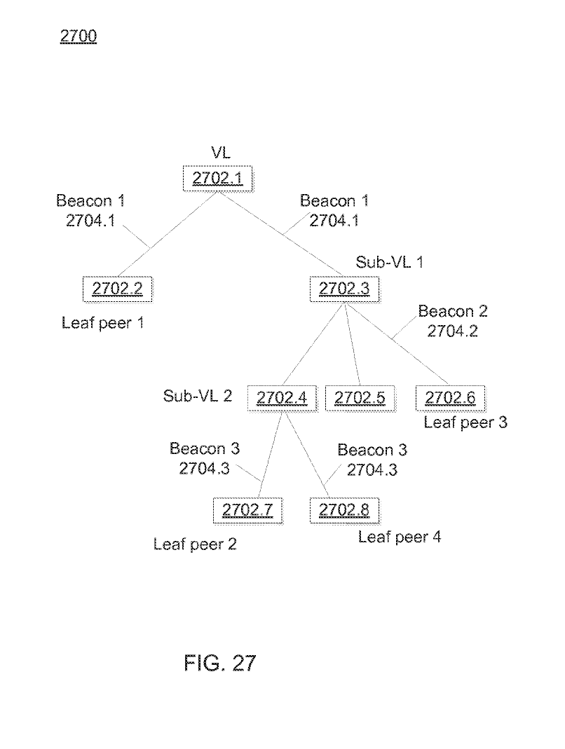

FIG. 27 illustrates an example of peers with distributed communication where peers may communicate with one another without sending and receiving data through an associated virtual leader or sub virtual leader.

Illustrated in FIG. 27 are peers 2702 and beacons 2704. The tree structure 2700 may illustrate the synchronization of the peers 2702. Peer 2702.1 may be a virtual leader. Peers 2702.3 and 2702.4 may be sub virtual leaders. Peers 2702.2, 2702.5, 2702.6, 2702.7, and 2702.8 may be leaf peers.

The peers 2702 may be configured to synchronize with peers 2702 that are horizontally to them on the tree structure 2700 in order to exchange data or control information. For example, leaf peer 2702.7 and leaf peer 4 2702.8 do not need to synchronize with one another because they both synchronize with sub VL 2 2702.4 via beacon 3 2704.3. However, leaf peer 2 2702.7 and leaf peer 3 2702.6 need to horizontally synchronize to exchange data or control information. Both, leaf peer 2 2702.7 and leaf peer 3 2702.6 are on the same sub-tree and both may be synchronized with virtual leader 2702.1; however, leaf peer 2 2702.7 and leaf peer 3 2702.8 receive different beacons 2704.

Peers 2702 may be configured to perform horizontal synchronization if there is data to transmit between the two peers and in vertical synchronization, two peers get synchronization information from different beacons received from a virtual leader or a sub virtual leader.

Vertical synchronization synchronizes peers 2702 with the associated virtual leader or sub virtual leader. Peers 2702 may be configured to perform horizontal synchronization using a synchronization header in a control and/or data packet (not illustrated.)

The peers disclosed herein may be configured to perform horizontal synchronization in accordance with the methods disclosed in conjuction with FIG. 27.

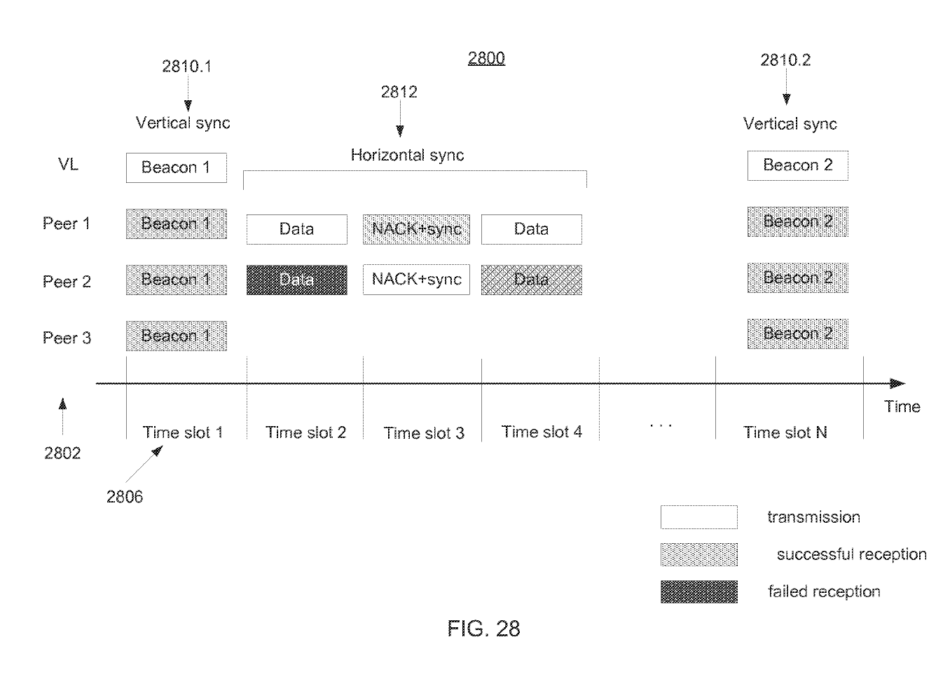

FIG. 28 illustrates an example of coordinating horizontal synchronization with vertical synchronization.

Illustrated in FIG. 28 are peers 2802 along the vertical axis, time slots 2806 along the horizontal axis, vertical synchronization 2810, horizontal synchronization 2812, and three types of messages beacons, data, and synchronization information.

Peers 2802 may be configured to perform horizontal synchronization at times when the vertical synchronization is not scheduled. For example, the peers 2802 may be synchronized with a virtual leader or sub virtual leader so that they know when the vertical synchronization 2810.1 and 2810.2 will occur.

The peers 2802 may be configured so that horizontal synchronization is triggered when there is data to exchange between two or more peers 2802. As illustrated, peer 1 2802 has data to send peer 2 2802. Peer 1 sends data along with a synchronization information at time slot 2 2806 and peer. Peer 2 reports at time slot 2 that the data was a failed reception. Peer 2 may send a nack and synchronization information in time slot 3 2806 to peer 1 2802. Peer 1 2802 may successfully receive the nack and synchronization information from peer 2. Peer 1 2802 may adjust its synchronization information based on the received nack and synchronization information from peer 2 2802. Peer 1 2802 may then transmit data to peer 2 2802 in time slot 4. Peer 2 2802 may receive the data successfully. Thus peer 1 and peer 2 performed horizontal synchronization without interfering with the vertical synchronization of the virtual leader. The peers disclosed herein may be configured to perform the horizontal synchronization as disclosed in conjunction with FIG. 28.

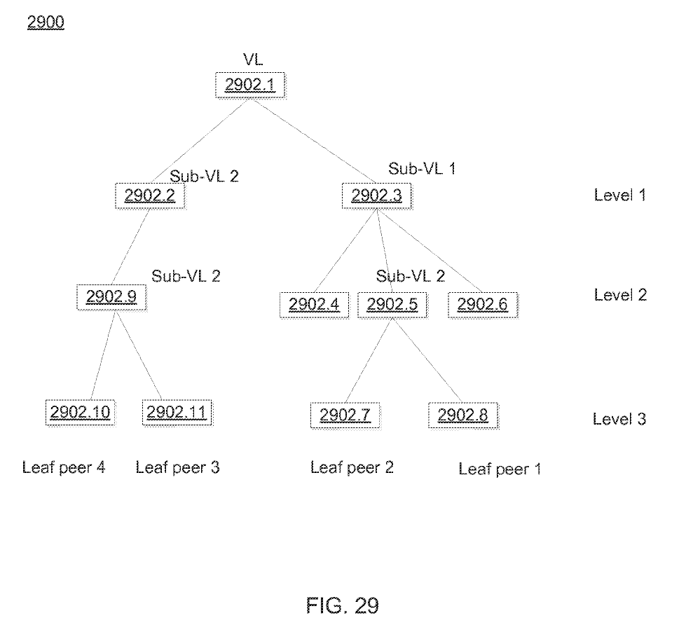

FIG. 29 illustrates an example of beacon-less synchronization for distributed communication. For beacon-less synchronization for distributed communication, the peers 2902 may be configured to synchronize by exchanging messages. The messages may be data packets or control packets without data. Every peer 2902 may be configured to synchronize with a virtual leader 2902.1 or a sub virtual leader 2902.2, 2902.3, 2902.9, 2902.5. The virtual leader 2902.1 or sub virtual leader 2902.2, 2902.3, 2902.9, 2902.5 may be called the time source. Peers 2902 may be configured to receive data packets and control packets from other peers 2902 and a virtual leader 2902.1 or a sub virtual leader 2902.2, 2902.3, 2902.9, 2902.5. Leaf peer 2 2902.7 may have three time sources to synchronize with because leaf peer 2 2902.7 exchanges data with sub virtual leader 2902.5, leaf peer 1 2902.8, and leaf peer 3 2902.11. The synchronization path (not illustrated) from the VL 2902.1 to leaf peer 2 2902.7 may be 2902.1 to 2902.3 to 2902.5, and then to leaf peer 2 2902.7.

The peers 2902 may be configured to perform the methods disclosed in conjunction with FIGS. 26 and 27. Based on the synchronization information from multiple time sources, the receiving peer 2902 may determine a suitable time offset.

The peers disclosed herein may be configured to perform the methods disclosed in conjunction with FIG. 29.

For Orthogonal Frequency-Division Multiple Access (OFDMA) or other types of communication that may require time and frequency synchronization, the peers may be configured to perform frequency synchronization as well as time synchronization directly with one another. For example, peer 1 may insert pilot information for frequency synchronization. Peer 2 2902.7 2902.8 may indicate both synchronization information in the response. Peer 2 2902.7 may indicate both frequency and time failures, since peer 2 2902.7 would not which failed.

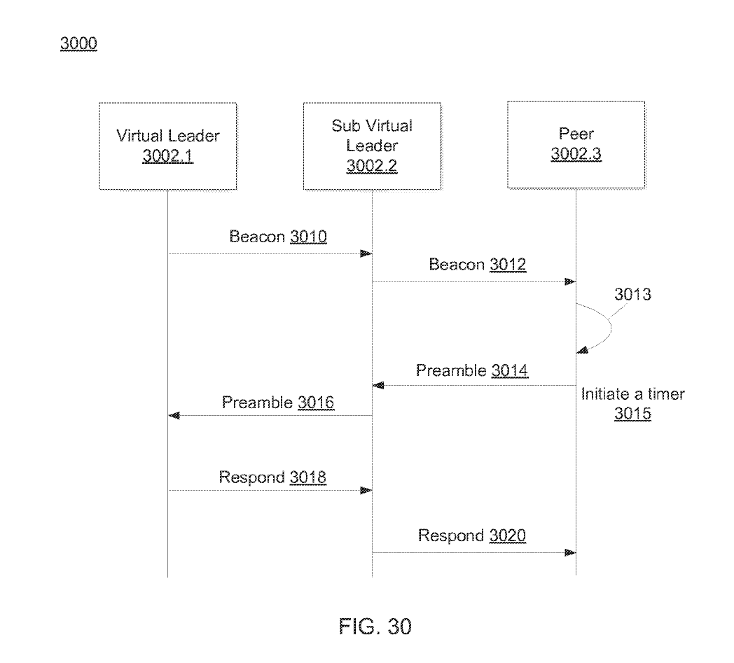

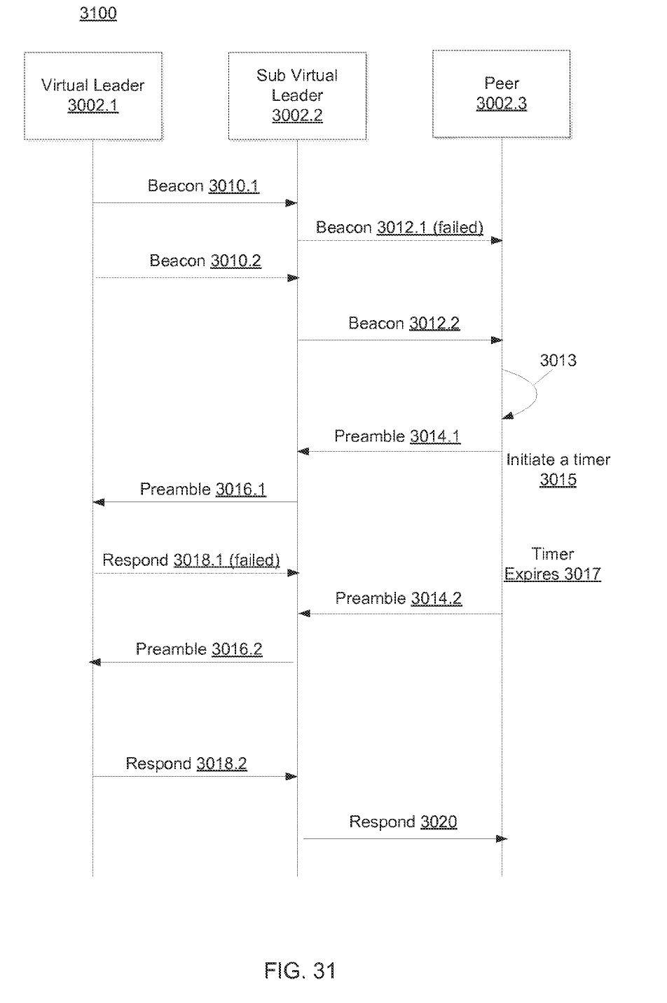

FIG. 30 illustrates a method of beacon-based multi-hop synchronization initiated by a peer in a peer-to-peer network with centralized communication.

With Orthogonal Frequency-Division Multiple Access (OFDMA), a virtual leader 3002.1 may be configured to periodically broadcast a beacon for time synchronization. For frequency domain synchronization, the virtual leader 3002.1 and/or the peers 3002 may be configured to use a pilot or a preamble. Examples of events that may initiate synchronization include a peer 3002 wanting to initiate a telephone call and a virtual leader 3002.1 wanting to initiate a new game within the peer-to-peer network of the virtual leader 3002.1.

The method 3000 may begin with the virtual leader 3002.1 broadcasting the beacon 3010. The method 3000 may continue with the sub virtual leader 3002.2 rebroadcasts the beacon 3012. The method 3000 may continue with peer 3002.3 receiving the beacon 3012 and extracting out the time information and synchronizing with the sub virtual leader 3002.2 3013. The peer 3002.3 may be configured to wait for a next beacon if the peer 3002.3 fails to receive the beacon 3012.

The method 3000 may continue with the peer 3002.3 sending a preamble 3014 which may be included in a control message. The peer 3002.3 may also initiate a timer 3015. The method 3000 may continue with the sub virtual leader 3002.2 receiving the preamble and relaying the preamble to the virtual leader 3002.1 at 3016.

The method 3000 may continue with the virtual leader 3002.1 receiving the preamble and does a correlation at the physical layer and sending a response message to the sub virtual leader 3002.2 at 3018. The method 3000 may continue with the sub virtual leader 3002.2 receiving the response 3018 and adjusting the frequency carrier according to the received response 3018. The sub virtual leader 3002.2 may send the response to the peer 3002.3 at 3020. The peer 3002.3 may adjust the frequency carrier according to the received response 3020. The peer 3002.3 may stop the timer.

FIG. 31 illustrates a method of beacon-based multi-hop synchronization initiated by a peer in a peer-to-peer network with centralized communication. Illustrated in FIG. 31 are illustrated how the methods may operate with a transmission error. If the beacon 3012.1 fails to be received by the peer 3002.3, then the sub virtual leader 3002.2 may be configured to relay the next beacon 3010.2 to the peer 3002.3. The sub virtual leader 3002.2 may relay all received beacons from the virtual leader 3002.1 to the peer 3002.3.

The respond 3018.1 may fail to be received by the sub virtual leader 3002.2. The peer 3002.3 may be configured to resend the preamble 3014.2 after the timer expires 3017 that was initiated at 3015.

Thus the peers 3002 may be configured to recover from some transmission errors. The peers disclosed herein may be configured to perform the methods disclosed in conjunction with FIGS. 30 and 31.

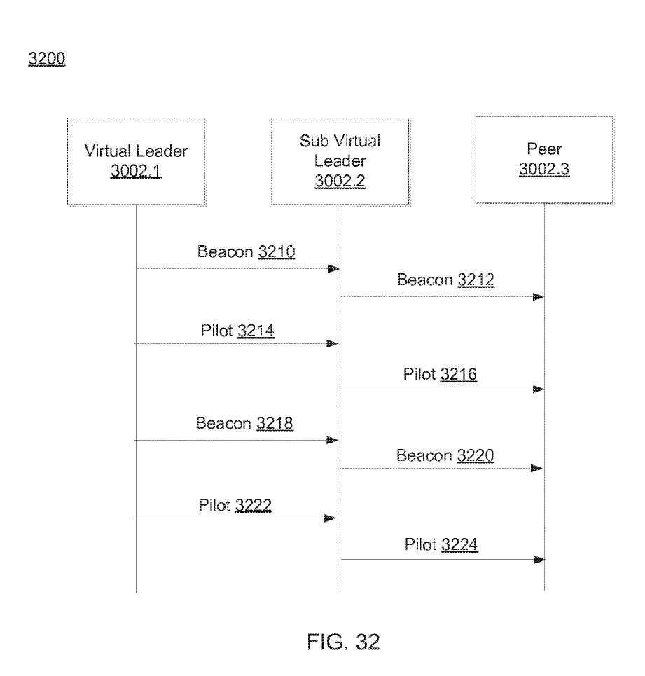

FIG. 32 illustrates a method of beacon-based multi-hop synchronization initiated in a peer-to-peer network with centralized communication.

In some embodiments, the virtual leader 3002.1 may be configured to initiate synchronization by sending beacons for time synchronization and sending control packets including pilots for frequency synchronization 3214, 3222. The virtual leader 3002.1 may be configured to send the beacons and pilots at different frequencies than are illustrated. For example, the virtual leader 3002.1 may send one pilot for each two beacons. The sub virtual leader 3002.2 may be configured to relay the beacons 3210, 3218 and the pilots 3214, 3222 to the peer 3002.3 by sending the beacons 3212, 3220 and the pilots 3212, 3224 to the peer 3002.3. The sub virtual leader 3002.2 and peer 3002.3 may be configured to synchronize using the beacons and pilots. Peers disclosed herein may be configured to perform the methods disclosed in conjunction with FIG. 32.

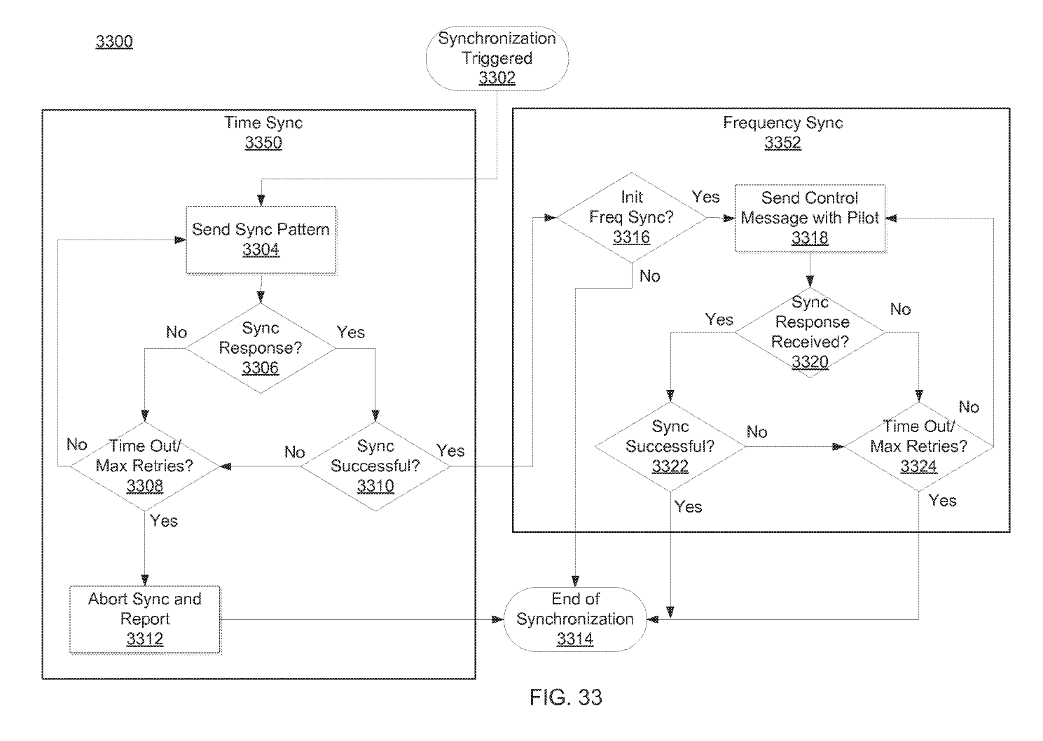

FIG. 33 illustrates an example of a method for beacon-less multi-hop synchronization on a virtual leader or a sub virtual leader.

The method 3300 may begin with the synchronization being triggered 3302. For example, the synchronization may be trigger by a peer. The synchronization may be triggered by a higher layer entity 308 to a management entity 308 (see FIG. 4). The synchronization may be triggered as part of a higher layer, peer discovery, peer association, or a new application being run on the peer.

The method 3300 may continue with sending a synchronization pattern 3304. For example, the VL or sub VL may send a beacon as illustrated in FIGS. 30, 31, and 32. The method 3300 may continue with determining whether or not a synchronization response was received 3306. For example, the VL or sub VL may receive a response to the beacon as illustrated in FIGS. 30 and 31.

If a synchronization response was not received, then the method 3300 may continue with determining whether or not a maximum number of retries has been reached or whether a timeout has expired 3308. If the maximum number of retries has not been reached and the timeout has not expired, then the method 3300 continues by returning to sending a synchronization pattern 3304.

If the maximum number of retries has been reached or the timeout has been reached, then the method 3300 continues with aborting the synchronization and reporting 3312. The method 3300 may abort and report failure to synchronize to a higher layer. The method 3300 then continues to end of synchronization 3314.

If a synchronization response has been received at 3306, then the method 3300 continues with determining whether or not the synchronization was successful 3310. If the synchronization was not successful, then the method 3300 continues with determining whether or not a maximum number of retries has been reached or whether a timeout has expired 3308 as discussed above. If the synchronization was successful, then the method 3300 continues into the frequency synchronization 3352 with determining whether or not to initiate frequency synchronization 3316. If frequency synchronization is not to be done, then the method 3300 may continue to end of synchronization 3314.

If frequency synchronization is to be initiated, then the method 3300 continues with sending control message with pilot 3318. For example, as illustrated in FIG. 32, the VL may send a control message with a pilot. The method 3300 may continue with determining whether or not a synchronization response is received 3320.

If a synchronization response was not received, then the method 3300 may continue with determining whether or not a maximum number of retries has been reached or whether a timeout has expired 3324. If the maximum number of retries has not been reached and the timeout has not expired, then the method 3300 continues by returning to sending control message with pilot 3318. For example, as illustrated in FIG. 31, the VL 3002.1 and the sub VL 3002.2 may resend synchronization messages.

If the maximum number of retries has been reached, then the method 3300 continues to end of synchronization 3314 where a report may be sent to a higher layer entity.

If the synchronization response was received at 3320, then the method 3300 may continue with determining whether or not the synchronization was successful. If the synchronization was successful, then the method 3300 may continue with ending the synchronization 3314 where a report may be sent to a higher layer entity. If the synchronization was not successful, then the method 3300 may continue with determining whether a time out occurred or a maximum number of retries has been reached 3324 as is discussed above.

In some embodiment, a VL or sub VL may initiate frequency synchronization 3352 before time synchronization 3350 has started or is completed.

Peers acting as virtual leaders or sub virtual leader as disclosed herein may be configured to perform the methods disclosed in conjunction with FIG. 33. In some embodiments, the method 3300 may be for Orthogonal Frequency-Division Multiple Access (OFDMA).

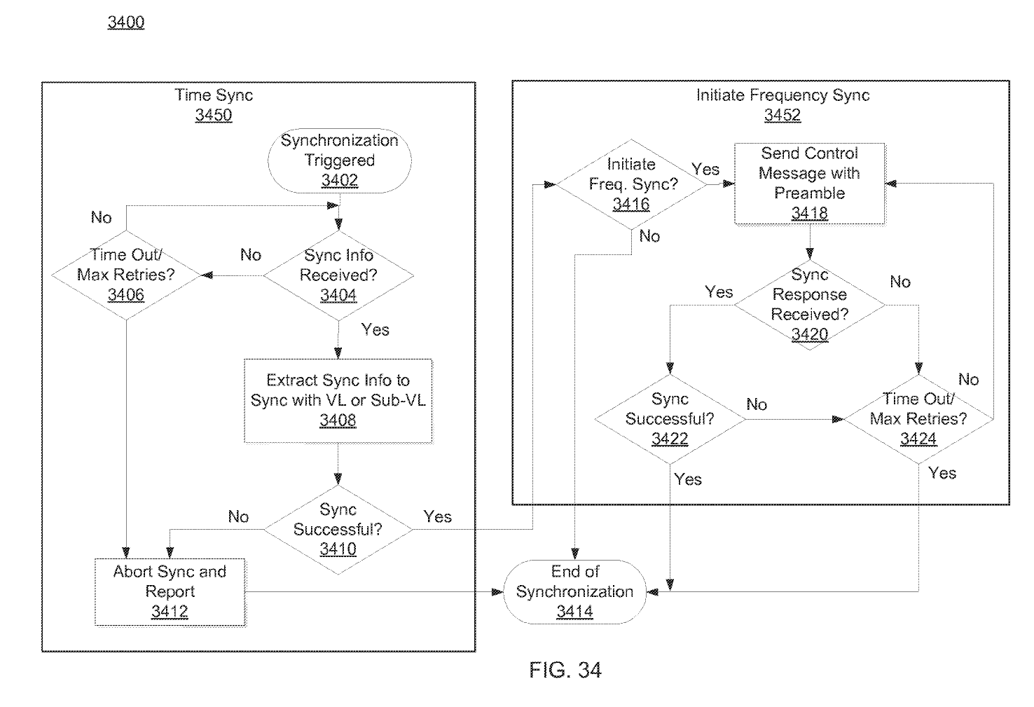

FIG. 34 illustrates an example of a method for beacon-less multi-hop synchronization on a peer

The method 3400 may begin with the synchronization being triggered 3402. For example, the synchronization may be trigger by a peer. The synchronization may be triggered by a higher layer entity 308 to a management entity 308 (see FIG. 4). The synchronization may be triggered as part of a higher layer, peer discovery, peer association, or a new application being run on the peer.

The method 3400 may continue with determining whether or not synchronization information was received 3404. For example, a peer may receive synchronization information such as a beacon as illustrated in FIGS. 30, 31, and 32.

If synchronization information was not received, then the method 3400 may continue with determining whether or not a maximum number of retries has been reached or whether a timeout has expired 3406. If the maximum number of retries has not been reached and the timeout has not expired, then the method 3400 continues by returning to determining whether or not synchronization information was received 3404.

If the maximum number of retries has been reached or the timeout has been reached, then the method 3400 continues with aborting the synchronization and reporting 3412. The method 3400 may abort and report failure to synchronize to a higher layer. The method 3400 then continues to end of synchronization 3414.

If synchronization information has been received at 3404, then the method 3400 continues with extracting synchronization information to synchronize with the VL or the sub VL 3408.

The method 3400 then continues with determining whether or not the synchronization was successful 3410. If the synchronization was not successful, then the method 3400 continues with aborting synchronization and reporting to a higher layer 3412 as discussed above.

If the synchronization was successful at 3410, then the a peer performing the method 3400 may have successfully performed a time synchronization 3450 with a VL or sub VL. The method 3400 to initiating frequency synchronization 3452 with determining whether or not to initiate frequency synchronization 3416. If it is determined not to initiate frequency synchronization, then the method 3400 may continue with ending the synchronization 3414. For example, in some embodiments, the VL or the sub VL may initiate frequency synchronization and not the peer.

If it is determined to initiate frequency synchronization at 3416, then the method 3400 may continue with sending a control message with a preamble 3418. For example, the peer in FIGS. 30 and 31 may be configured to send a control message with a preamble to initiate frequency synchronization with a VL or a sub VL.

The method 3400 may continue with determining whether a synchronization response was received 3420. If a synchronization response was not received, then the method 3400 may continue with determining whether or not a maximum number of retries has been reached or whether a timeout has expired 3424. If the maximum number of retries has not been reached and the timeout has not expired, then the method 3400 continues by returning to sending control message with preamble 3418. For example, as illustrated in FIG. 31, the peer 3002.3 may resend preamble 3014.2.

If the maximum number of retries has been reached, then the method 3400 continues to end of synchronization 3414 where a report may be sent to a higher layer entity.

If the synchronization response was received at 3420, then the method 3400 may continue with determining whether or not the synchronization was successful 3422. If the synchronization was successful, then the method 3400 may continue with ending the synchronization 3414 where a report may be sent to a higher layer entity. If the synchronization was not successful, then the method 3400 may continue with determining whether a time out occurred or a maximum number of retries has been reached 3424 as is discussed above.

Peers acting as disclosed herein may be configured to perform the methods disclosed in conjunction with FIG. 34. In some embodiments, the method 3300 may be for Orthogonal Frequency-Division Multiple Access (OFDMA).

In some embodiment, the peer may initiate frequency synchronization 3452 before time synchronization 3450 has started or is completed.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method on a wireless transmit/receive unit (WTRU) for peer-to-peer communication, the method comprising:
on a condition of receiving a super beacon,
extracting from the super beacon application synchronization information,
on a condition the extracted application synchronization information includes first application synchronization information for a first application,
synchronizing with a first beacon of the first application based on the first application synchronization information.

2. The method of claim 1, further comprising:
receiving a first frame associated with the first application transmitted by a first peer of the WTRU as part of peer-to-peer communication associated with the first application.

3. The method of claim 1, wherein the synchronizing with the first beacon of the first application comprises:
determining a first time to scan for the first beacon of the first application based on the extracted first synchronization information; and
scanning for the first beacon of the first application at the determined first time.

4. The method of claim 3, wherein the determining comprises: determining the first time to scan for the first beacon of the first application by extracting from the application synchronization information first application synchronization information including a first application offset, and determining a first time for the first beacon by adding the first application offset to a time associated with when the super beacon was received.

5. The method of claim 1, further comprising:
on a condition of receiving a second beacon associated with a second application,
extracting from the second beacon super beacon synchronization information,
synchronizing with the super beacon based on the extracted super beacon synchronization information, and
extracting from the super beacon application synchronization information.

6. The method of claim 5, wherein the super beacon synchronization information is a super beacon offset, and wherein the super beacon offset indicates an offset time for the super beacon from when the second beacon was received.

7. The method of claim 1, wherein the extracted application synchronization information includes an application offset list (AOL) including synchronization information for one or more applications.

8. The method of claim 1, further comprising:
receiving the first application as context information from a higher layer entity; and wherein on the condition the extracted application synchronization information further comprises:
returning the extracted application synchronization information to the higher layer entity, and
receiving an instruction from the higher layer entity to synchronize with the first application based on the extracted application synchronization information.

9. The method of claim 1, wherein the super beacon was received from a super virtual leader.

10. A wireless transmit/receive unit (WTRU) for peer-to-peer communication, the WTRU comprising:
a transceiver configured to:
receive a super beacon,
extract from the received super beacon application synchronization information, and
synchronize with a first beacon of a first application based on a first application synchronization information, if the extracted application synchronization information includes first application synchronization information for the first application.

11. The WTRU of claim 10, wherein the transceiver is further configured to:
receive a first frame associated with the first application transmitted by a first peer of the WTRU as part of peer-to-peer communication associated with the first application.

12. The WTRU of claim 10, wherein the transceiver is further configured to:
determine a first time to scan for the first beacon of the first application based on the extracted first synchronization information, and
scan for the first beacon of the first application at the determined first time, in order to synchronize with the first beacon.

13. The WTRU of claim 10, wherein the extracted application synchronization information includes an application offset list (AOL) including synchronization information for one or more applications.

14. A method on a wireless transmit/receive unit (WTRU) for peer-to-peer communication, the method comprising:
on a condition a received beacon is for a first application,
extracting first application synchronization information from the received beacon,
otherwise
extracting common beacon synchronization information from the received beacon,
scanning for the common beacon based on the extracted common beacon synchronization information,
receiving the common beacon, and
extracting common channel synchronization information from the common beacon.

15. The method of claim 14, wherein the common beacon synchronization information is a common beacon offset.

16. The method of claim 14, further comprising before the otherwise,
on a condition a maximum scan has not been reached,
extracting an application end offset from the received beacon and scanning for a next beacon.

17. The method of claim 14, further comprising:
synchronizing with a first beacon of the first application based on the first synchronization information, and
receiving a first frame associated with the first application transmitted by a first peer of the WTRU as part of peer-to-peer communication associated with the first application.

18. A wireless transmit/receive unit (WTRU), the WTRU comprising:
a transceiver configured to:
receive a beacon;
extract first application synchronization information from the received beacon, if the received beacon is for a first application; and
if the received beacon is not for the first application, then extract common beacon synchronization information from the received beacon, scan for the common beacon based on the extracted common beacon synchronization information, receive the common beacon, and extract common channel synchronization information from the common beacon, if the received beacon is not for the first application.

19. A method on a wireless transmit/receive unit (WTRU) for peer-to-peer communication, the method comprising:
on a condition there is data to be transmitted, transmitting synchronization information in a data packet to a second WTRU, otherwise transmitting synchronization information in a dummy packet to the second WTRU;
on a condition that a synchronization response is received from the second WTRU,
determining whether or not the synchronization response indicates that the synchronization was successful, and if the synchronization response indicates the synchronization was not successful then re-transmitting the data packet or the dummy packet.

20. The method of claim 19, further comprising:
on a condition that the synchronization response is not received, re-transmitting the data packet or the dummy packet.
